(19) United States
(12) Patent Application Publication
(10) Pub. No.: US 2025/0344089 A1
(43) Pub. Date: Nov. 6, 2025

(54) MULTI-PORT REFERENCE SIGNAL RESOURCE CONFIGURATION FOR HIGH RANK MULTIPLE-INPUT MULTIPLE-OUTPUT SYSTEMS

(71) Applicant: QUALCOMM Incorporated, San Diego, CA (US)

(72) Inventors: Kiran VENUGOPAL, Green Brook, NJ (US); Yu ZHANG, San Diego, CA (US); Jing SUN, San Diego, CA (US)

(21) Appl. No.: 18/655,563

(22) Filed: May 6, 2024

(51) Int. Cl. H04W 24/10; H04B 7/0417; H04L 5/00

(52) U.S. Cl. CPC H04W 24/10; H04B 7/0417; H04L 5/0051

(57) ABSTRACT

Methods, systems, and devices for wireless communication are described. Various aspects relate to a user equipment (UE) and a network entity that support one or more mechanisms associated with a multi-port channel state information (CSI) configuration for beam management. Some aspects more specifically relate to a reference signal resource setting indicating at least one reference signal resource set that includes at least one reference signal resource associated with more than two ports. To facilitate feedback from the UE associated with such a multi-port CSI configuration for beam management, some further aspects relate to a report quantity associated with a single reference signal resource indicator and multiple measurement metrics. A UE, in accordance with being configured with the reference signal resource setting and the report quantity, may perform one or more reference signal measurements and may feedback a report associated with the reference signal measurements.

### FIELD OF TECHNOLOGY

The following relates to wireless communication, including multi-port reference signal resource configuration for high rank multiple-input multiple-output (MIMO) systems.

### BACKGROUND

Wireless communication systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communication system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving first information indicative of at least a first reference signal resource set, the first reference signal resource set including a set of reference signal resources, receiving second information indicative of a report quantity associated with at least the first reference signal resource set, where the report quantity is associated with a single reference signal resource indicator and a set of multiple measurement metrics, and transmitting, in accordance with the report quantity, a report including an indication of a first reference signal resource indicator associated with a reference signal resource of the set of reference signal resources and a first set of multiple measurement metrics associated with the reference signal resource of the set of reference signal resources.

An apparatus for wireless communication at a UE is described. The apparatus or the UE may include one or more memories storing processor executable code and one or more processors coupled with the one or more memories. The one or more processors may individually or collectively be operable to execute the code to cause the UE to receive first information indicative of at least a first reference signal resource set, the first reference signal resource set including a set of reference signal resources, receive second information indicative of a report quantity associated with at least the first reference signal resource set, where the report quantity is associated with a single reference signal resource indicator and a set of multiple measurement metrics, and transmit, in accordance with the report quantity, a report including an indication of a first reference signal resource indicator associated with a reference signal resource of the set of reference signal resources and a first set of multiple measurement metrics associated with the reference signal resource of the set of reference signal resources.

Another apparatus for wireless communication at a UE is described. The apparatus or the UE may include means for receiving first information indicative of at least a first reference signal resource set, the first reference signal resource set including a set of reference signal resources, means for receiving second information indicative of a report quantity associated with at least the first reference signal resource set, where the report quantity is associated with a single reference signal resource indicator and a set of multiple measurement metrics, and means for transmitting, in accordance with the report quantity, a report including an indication of a first reference signal resource indicator associated with a reference signal resource of the set of reference signal resources and a first set of multiple measurement metrics associated with the reference signal resource of the set of reference signal resources.

A non-transitory computer-readable medium storing code for wireless communication is described. The code may include instructions executable by one or more processors to receive first information indicative of at least a first reference signal resource set, the first reference signal resource set including a set of reference signal resources, receive second information indicative of a report quantity associated with at least the first reference signal resource set, where the report quantity is associated with a single reference signal resource indicator and a set of multiple measurement metrics, and transmit, in accordance with the report quantity, a report including an indication of a first reference signal resource indicator associated with a reference signal resource of the set of reference signal resources and a first set of multiple measurement metrics associated with the reference signal resource of the set of reference signal resources.

Some examples of the method, UEs, and non-transitory computer-readable medium described herein may further include operations, features, means, or instructions for receiving, via the first information, an indication that a repetition associated with the set of reference signal resources may be enabled, where transmitting the report may be in association with the repetition being enabled.

Some examples of the method, UEs, and non-transitory computer-readable medium described herein may further include operations, features, means, or instructions for receiving, via the first information or the second information, an indication of a rank hypothesis associated with the set of reference signal resources, where a first quantity of the first set of multiple measurement metrics may be equal to a value of the rank hypothesis.

In some examples of the method, UEs, and non-transitory computer-readable medium described herein, the first quantity of the first set of multiple measurement metrics may be less than or equal to a second quantity of ports associated with the reference signal resource.

In some examples of the method, UEs, and non-transitory computer-readable medium described herein, the indication of the rank hypothesis indicates a mode of operation for communication between the UE and a network entity, the mode of operation includes single user (SU) multiple-input multiple-output (MIMO) operation with a rank greater than two, and transmitting the report may be in accordance with the mode of operation.

Some examples of the method, UEs, and non-transitory computer-readable medium described herein may further include operations, features, means, or instructions for receiving, via the first information, an indication of a mode of operation for communication between the UE and a network entity, where the mode of operation includes single user (SU) multiple-input multiple-output (MIMO) operation with a rank greater than two, and where transmitting the report may be in accordance with the mode of operation.

In some examples of the method, UEs, and non-transitory computer-readable medium described herein, a first quantity of the first set of multiple measurement metrics may be based on a second quantity of ports associated with the reference signal resource.

Some examples of the method, UEs, and non-transitory computer-readable medium described herein may further include operations, features, means, or instructions for inputting, into a function, the second quantity of ports associated with the reference signal resource and obtaining, as an output of the function, the first quantity.

Some examples of the method, UEs, and non-transitory computer-readable medium described herein may further include operations, features, means, or instructions for receiving, via the first information, an indication of a respective set of quasi-co-location reference signals associated with each reference signal resource of the set of reference signal resources.

In some examples of the method, UEs, and non-transitory computer-readable medium described herein, a quantity of the respective set of quasi-co-location reference signals associated with each reference signal resource of the set of reference signal resources may be less than or equal to a respective quantity of ports associated with that reference signal resource of the set of reference signal resources.

In some examples of the method, UEs, and non-transitory computer-readable medium described herein, the reference signal resource may be associated with a set of multiple quasi-co-location reference signals of a first quantity and a second quantity of the first set of multiple measurement metrics may be based on the first quantity.

Some examples of the method, UEs, and non-transitory computer-readable medium described herein may further include operations, features, means, or instructions for receiving, via the first information, an indication of a same quantity of ports associated with each reference signal resource of the set of reference signal resources, where the same quantity of ports may be greater than two.

Some examples of the method, UEs, and non-transitory computer-readable medium described herein may further include operations, features, means, or instructions for receiving, via the first information, an indication of a respective quantity of ports associated with each reference signal resource of the set of reference signal resources.

In some examples of the method, UEs, and non-transitory computer-readable medium described herein, the reference signal resource may be associated with a first quantity of ports, a second reference signal resource of the set of reference signal resources may be associated with a second quantity of ports different than the first quantity of ports, and at least the first quantity of ports may be greater than two.

Some examples of the method, UEs, and non-transitory computer-readable medium described herein may further include operations, features, means, or instructions for transmitting, via the report or a second report associated with the reference signal resource, an indication of a precoding matrix indicator and an indication of a channel quality indictor associated with the reference signal resource.

Some examples of the method, UEs, and non-transitory computer-readable medium described herein may further include operations, features, means, or instructions for receiving, via the second information, an indication that the report quantity may be further associated with a rank indication and transmitting, via the report, a first rank indication associated with the reference signal resource, where a first quantity of the first set of multiple measurement metrics may be equal to a value of the first rank indication.

In some examples of the method, UEs, and non-transitory computer-readable medium described herein, the value of the first rank indication may be less than or equal to a second quantity of ports associated with the reference signal resource.

In some examples of the method, UEs, and non-transitory computer-readable medium described herein, each measurement metric of the first set of multiple measurement metrics may be associated with a respective multiple-input multiple-output (MIMO) layer at the UE.

Some examples of the method, UEs, and non-transitory computer-readable medium described herein may further include operations, features, means, or instructions for receiving third information indicative of a channel measurement resource, where the third information includes an indication of the reference signal resource as a quasi-co-location reference signal for the channel measurement resource in accordance with the report, and where the reference signal resource may be associated with a set of multiple ports in accordance with the first information.

Some examples of the method, UEs, and non-transitory computer-readable medium described herein may further include operations, features, means, or instructions for transmitting, in accordance with the third information, a second report including at least a portion of channel state information associated with the channel measurement resource.

Some examples of the method, UEs, and non-transitory computer-readable medium described herein may further include operations, features, means, or instructions for buffering channel state information associated with the reference signal resource in association with a measurement of the reference signal resource, receiving a request for the channel state information associated with the reference signal resource, and transmitting, in accordance with the request, a second report including the channel state information associated with the reference signal resource.

In some examples of the method, UEs, and non-transitory computer-readable medium described herein, the first set of multiple measurement metrics may be based on a singular value decomposition of an effective channel of each multiple-input multiple-output (MIMO) layer at the UE.

In some examples of the method, UEs, and non-transitory computer-readable medium described herein, the first set of multiple measurement metrics may be further based on a wideband precoder, the wideband precoder may be associated with a set of multiple precoder coefficients, and each precoder coefficient of the set of multiple precoder coefficients may be applied to a respective transmit beam associated with the reference signal resource.

Some examples of the method, UEs, and non-transitory computer-readable medium described herein may further include operations, features, means, or instructions for measuring each reference signal resource of the set of reference signal resources in accordance with the report quantity, where transmitting the report may be in association with measuring each reference signal resource of the set of reference signal resources.

In some examples of the method, UEs, and non-transitory computer-readable medium described herein, the first information may be associated with a beam management between the UE and a network entity and the first set of multiple measurement metrics includes a set of multiple reference signal receive power (RSRP) metrics or a set of multiple signal-to-interference-plus-noise ratio (SINR) metrics.

A method for wireless communication by a network entity is described. The method may include outputting first information indicative of at least a first reference signal resource set, the first reference signal resource set including a set of reference signal resources, outputting second information indicative of a report quantity associated with at least the first reference signal resource set, where the report quantity is associated with a single reference signal resource indicator and a set of multiple measurement metrics, and obtaining, in accordance with the report quantity, a report including an indication of a first reference signal resource indicator associated with a reference signal resource of the set of reference signal resources and a first set of multiple measurement metrics associated with the reference signal resource of the set of reference signal resources.

An apparatus for wireless communication at a network entity is described. The apparatus or the network entity may include one or more memories storing processor executable code, and one or more processors coupled with the one or more memories. The one or more processors may individually or collectively be operable to execute the code to cause the network entity to output first information indicative of at least a first reference signal resource set, the first reference signal resource set including a set of reference signal resources, output second information indicative of a report quantity associated with at least the first reference signal resource set, where the report quantity is associated with a single reference signal resource indicator and a set of multiple measurement metrics, and obtain, in accordance with the report quantity, a report including an indication of a first reference signal resource indicator associated with a reference signal resource of the set of reference signal resources and a first set of multiple measurement metrics associated with the reference signal resource of the set of reference signal resources.

Another apparatus for wireless communication at a network entity is described. The apparatus or the network entity may include means for outputting first information indicative of at least a first reference signal resource set, the first reference signal resource set including a set of reference signal resources, means for outputting second information indicative of a report quantity associated with at least the first reference signal resource set, where the report quantity is associated with a single reference signal resource indicator and a set of multiple measurement metrics, and means for obtaining, in accordance with the report quantity, a report including an indication of a first reference signal resource indicator associated with a reference signal resource of the set of reference signal resources and a first set of multiple measurement metrics associated with the reference signal resource of the set of reference signal resources.

A non-transitory computer-readable medium storing code for wireless communication is described. The code may include instructions executable by one or more processors to output first information indicative of at least a first reference signal resource set, the first reference signal resource set including a set of reference signal resources, output second information indicative of a report quantity associated with at least the first reference signal resource set, where the report quantity is associated with a single reference signal resource indicator and a set of multiple measurement metrics, and obtain, in accordance with the report quantity, a report including an indication of a first reference signal resource indicator associated with a reference signal resource of the set of reference signal resources and a first set of multiple measurement metrics associated with the reference signal resource of the set of reference signal resources.

Some examples of the method, network entities, and non-transitory computer-readable medium described herein may further include operations, features, means, or instructions for outputting, via the first information, an indication that a repetition associated with the set of reference signal resources may be enabled, where obtaining the report may be in association with the repetition being enabled.

Some examples of the method, network entities, and non-transitory computer-readable medium described herein may further include operations, features, means, or instructions for outputting, via the first information or the second information, an indication of a rank hypothesis associated with the set of reference signal resources, where a first quantity of the first set of multiple measurement metrics may be equal to a value of the rank hypothesis.

In some examples of the method, network entities, and non-transitory computer-readable medium described herein, the first quantity of the first set of multiple measurement metrics may be less than or equal to a second quantity of ports associated with the reference signal resource.

In some examples of the method, network entities, and non-transitory computer-readable medium described herein, the indication of the rank hypothesis indicates a mode of operation for communication between the network entity and a UE, the mode of operation includes single user (SU) multiple-input multiple-output (MIMO) operation with a rank greater than two, and obtaining the report may be in accordance with the mode of operation.

Some examples of the method, network entities, and non-transitory computer-readable medium described herein may further include operations, features, means, or instructions for outputting, via the first information, an indication of a mode of operation for communication between the network entity and a UE, where the mode of operation includes single user (SU) multiple-input multiple-output (MIMO) operation with a rank greater than two, and where obtaining the report may be in accordance with the mode of operation.

In some examples of the method, network entities, and non-transitory computer-readable medium described herein, a first quantity of the first set of multiple measurement metrics may be based on a second quantity of ports associated with the reference signal resource.

Some examples of the method, network entities, and non-transitory computer-readable medium described herein may further include operations, features, means, or instructions for inputting, into a function, the second quantity of ports associated with the reference signal resource and obtaining, as an output of the function, the first quantity.

Some examples of the method, network entities, and non-transitory computer-readable medium described herein may further include operations, features, means, or instructions for outputting, via the first information, an indication of a respective set of quasi-co-location reference signals associated with each reference signal resource of the set of reference signal resources.

In some examples of the method, network entities, and non-transitory computer-readable medium described herein, a quantity of the respective set of quasi-co-location reference signals associated with each reference signal resource of the set of reference signal resources may be less than or equal to a respective quantity of ports associated with that reference signal resource of the set of reference signal resources.

In some examples of the method, network entities, and non-transitory computer-readable medium described herein, the reference signal resource may be associated with a set of multiple quasi-co-location reference signals of a first quantity and a second quantity of the first set of multiple measurement metrics may be based on the first quantity.

Some examples of the method, network entities, and non-transitory computer-readable medium described herein may further include operations, features, means, or instructions for outputting, via the first information, an indication of a same quantity of ports associated with each reference signal resource of the set of reference signal resources, where the same quantity of ports may be greater than two.

Some examples of the method, network entities, and non-transitory computer-readable medium described herein may further include operations, features, means, or instructions for outputting, via the first information, an indication of a respective quantity of ports associated with each reference signal resource of the set of reference signal resources.

In some examples of the method, network entities, and non-transitory computer-readable medium described herein, the reference signal resource may be associated with a first quantity of ports, a second reference signal resource of the set of reference signal resources may be associated with a second quantity of ports different than the first quantity of ports, and at least the first quantity of ports may be greater than two.

Some examples of the method, network entities, and non-transitory computer-readable medium described herein may further include operations, features, means, or instructions for obtaining, via the report or a second report associated with the reference signal resource, an indication of a precoding matrix indicator and an indication of a channel quality indictor associated with the reference signal resource.

Some examples of the method, network entities, and non-transitory computer-readable medium described herein may further include operations, features, means, or instructions for outputting, via the second information, an indication that the report quantity may be further associated with a rank indication and obtaining, via the report, a first rank indication associated with the reference signal resource, where a first quantity of the first set of multiple measurement metrics may be equal to a value of the first rank indication.

In some examples of the method, network entities, and non-transitory computer-readable medium described herein, the value of the first rank indication may be less than or equal to a second quantity of ports associated with the reference signal resource.

In some examples of the method, network entities, and non-transitory computer-readable medium described herein, each measurement metric of the first set of multiple measurement metrics may be associated with a respective multiple-input multiple-output (MIMO) layer at a UE.

Some examples of the method, network entities, and non-transitory computer-readable medium described herein may further include operations, features, means, or instructions for outputting third information indicative of a channel measurement resource, where the third information includes an indication of the reference signal resource as a quasi-co-location reference signal for the channel measurement resource in accordance with the report, and where the reference signal resource may be associated with a set of multiple ports in accordance with the first information.

Some examples of the method, network entities, and non-transitory computer-readable medium described herein may further include operations, features, means, or instructions for obtaining, in accordance with the third information, a second report including at least a portion of channel state information associated with the channel measurement resource.

Some examples of the method, network entities, and non-transitory computer-readable medium described herein may further include operations, features, means, or instructions for outputting a request for buffered channel state information associated with the reference signal resource and obtaining, in accordance with the request, a second report including the buffered channel state information associated with the reference signal resource.

In some examples of the method, network entities, and non-transitory computer-readable medium described herein, the first set of multiple measurement metrics may be based on a singular value decomposition of an effective channel of each multiple-input multiple-output (MIMO) layer at a UE.

In some examples of the method, network entities, and non-transitory computer-readable medium described herein, the first set of multiple measurement metrics may be further based on a wideband precoder, the wideband precoder may be associated with a set of multiple precoder coefficients, and each precoder coefficient of the set of multiple precoder coefficients may be applied to a respective transmit beam associated with the reference signal resource.

In some examples of the method, network entities, and non-transitory computer-readable medium described herein, the first information may be associated with a beam management between the network entity and a UE and the first set of multiple measurement metrics includes a set of multiple reference signal receive power (RSRP) metrics or a set of multiple signal-to-interference-plus-noise ratio (SINR) metrics.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example of a wireless communication system that supports multi-port reference signal resource configuration for high rank multiple-input multiple-output (MIMO) systems in accordance with one or more aspects of the present disclosure.

FIGS. 2 and 3 show examples of a directional communication diagram that supports multi-port reference signal resource configuration for high rank MIMO systems in accordance with one or more aspects of the present disclosure.

FIG. 4 shows an example of a signaling diagram that supports multi-port reference signal resource configuration for high rank MIMO systems in accordance with one or more aspects of the present disclosure.

FIG. 5 shows an example of a process flow that supports multi-port reference signal resource configuration for high rank MIMO systems in accordance with one or more aspects of the present disclosure.

FIGS. 6 and 7 show block diagrams of devices that support multi-port reference signal resource configuration for high rank MIMO systems in accordance with one or more aspects of the present disclosure.

FIG. 8 shows a block diagram of a communication manager that supports multi-port reference signal resource configuration for high rank MIMO systems in accordance with one or more aspects of the present disclosure.

FIG. 9 shows a diagram of a system including a device that supports multi-port reference signal resource configuration for high rank MIMO systems in accordance with one or more aspects of the present disclosure.

FIGS. 10 and 11 show block diagrams of devices that support multi-port reference signal resource configuration for high rank MIMO systems in accordance with one or more aspects of the present disclosure.

FIG. 12 shows a block diagram of a communication manager that supports multi-port reference signal resource configuration for high rank MIMO systems in accordance with one or more aspects of the present disclosure.

FIG. 13 shows a diagram of a system including a device that supports multi-port reference signal resource configuration for high rank MIMO systems in accordance with one or more aspects of the present disclosure.

FIGS. 14 through 17 show flowcharts illustrating methods that support multi-port reference signal resource configuration for high rank MIMO systems in accordance with one or more aspects of the present disclosure.

### DETAILED DESCRIPTION

In some wireless communication systems, two or more wireless communication devices may communicate with each other using directional communication. Such directional communication, which may be referred to herein as beamforming or beam-based communication, may refer to how a wireless communication device may apply or use (e.g., to or at one or more antenna panels, arrays, or sub-arrays of the wireless communication device) a configuration associated with directional communication to form one or more directional beams. For example, a wireless communication device may transmit or receive a message or other signaling via a “beam,” which may also be understood as a spatial layer. A wireless communication device may achieve a configuration associated with directional communication via analog beamforming, digital beamforming, or hybrid beamforming (e.g., a combination of analog and digital beamforming). Additionally, in some wireless communication systems, two or more wireless communication devices may support a rank (e.g., a quantity of spatial layers) of greater than two (e.g., rank >2) for multiple-input multiple-output (MIMO) communication, including single user (SU) MIMO (SU-MIMO) communication. In such systems, one or more wireless communication devices, such as a user equipment (UE) and a network entity, may support more than one cross-polarized panel at transmit and receive sides, as each panel may support up to rank-2 MIMO via two ports. In some aspects, a UE may select to use different beams across the different panels of the UE to avoid a low rank condition for a beamformed channel. In such aspects, to select the beams (e.g., configurations associated with directional communication) for the different panels (to support a rank of greater than two), a UE and a network entity may perform a beam management procedure to measure, identify, determine, or otherwise ascertain which beams (of a larger set of possible beams) to use.

In some systems, however, the beam management procedure may not be suitable for beam selection for high rank (e.g., rank >2) communication, including high rank SU-MIMO communication. For example, some beam management procedures may be designed to address a poor receive signal-to-noise ratio (SNR) issue and may be prioritized before channel state information (CSI) acquisition. In accordance with such a prioritization of beam selection to address SNR prior to CSI acquisition, some beam management procedures may restrict a MIMO channel into a “dominant” subspace of the available dimension (which may result in the MIMO channel being rank deficient). In other words, a UE or a network entity may select a set of one or more beams for communication based on SNR and may not determine the CSI associated with the selected set of beams until after (and potentially long after) the beams have been selected for communication. Further, some beam management procedures may facilitate an individual selection of beams (e.g., beams associated with transmit-receive beam pairs) based on a measurement metric without sufficiently accounting for a correlation or interaction between multiple candidate beams. Such a lack of cross-beam correlation or interaction may result in a poor (e.g., not fully informed) beam selection, which may adversely impact a communication reliability or throughput (especially for high rank SU-MIMO communication, for which a correlation or interaction between beams may be especially impactful to reliability and throughput).

In accordance with some example implementations of the present disclosure, a UE and a network entity (or any other of various wireless communication devices) may support one or more signaling- or configuration-based mechanisms associated with a multi-port CSI configuration for beam management. To support such a multi-port CSI configuration for beam management, the network entity may configure (e.g., transmit information indicative of) a reference signal resource setting (e.g., a CSI reference signal (CSI-RS) resource setting) indicating at least one reference signal resource set that includes at least one reference signal resource associated with a quantity of K>2 ports. Further, to facilitate feedback from the UE associated with such a multi-port CSI configuration for beam management, the network entity may configure (e.g., transmit information indicative of) a report quantity associated with a single reference signal resource indicator, such as a single CSI-RS resource indicator (CRI), and multiple measurement metrics. The UE, in accordance with being configured with the reference signal resource setting and the report quantity, may perform one or more reference signal (e.g., CSI-RS) measurements and feedback (e.g., transmit information indicative of) a report associated with the reference signal measurements.

In some aspects, the UE may transmit a report indicating a reference signal resource indicator (e.g., a selected CRI) and multiple measurement metrics associated with the CRI. In such aspects, the reference signal resource indicator may correspond to a reference signal resource associated with a quantity of K>2 ports and the multiple measurement metrics may include a quantity of M≤K measurement metrics. In some examples, M may be associated with or otherwise indicative of a rank hypothesis associated with the reported/indicated reference signal resource, and may be associated with (e.g., determined based on) K, a quantity of N≤K quasi-co-location (QCL) reference signals associated with the reference signal resource, or indicated via the reference signal resource setting. Further, as used herein, a “measurement metric” may refer to or may otherwise be understood as an reference signal receive power (RSRP)-equivalent metric, such as an RSRP metric, a signal-to-interference-plus-noise ratio (SINR) metric, or a channel quality indicator (CQI) metric, among other examples.

Particular aspects of the subject matter described in this disclosure can be implemented to realize one or more of the following potential advantages. In some examples, by supporting the example reference signal resource settings and report quantities, the network entity may facilitate a more informed beam selection procedure such that CSI is accounted for in beam management, which may result in a more suitable set of beams being selected for communication between the network entity and the UE, including for SU-MIMO communication. For example, in accordance with the example reference signal resource settings and report quantities, the UE and the network entity may more accurately measure, determine, or otherwise ascertain an interaction or correlation between beams during beam management, which may result in a selection of beams that provide greater communication reliability and throughput between the UE and the network entity. Further, in accordance with the disclosed multi-port CSI configuration for beam management, the network entity may facilitate a measurement and selection of beams jointly by simultaneously (or within a relatively short time period) involving multiple transmit-receive panels, which may further avoid a mismatch or calibration issue at one or both of the UE or the network entity. In accordance with such greater reliability, greater throughput, and reduced likelihood for a mismatch or mis-calibration, some example implementations of the described reference signal resource settings and report quantities may further support higher data rates, higher spectrum efficiency, greater power savings by way of fewer communication errors (and fewer retransmissions), and greater system capacity, among other benefits.

Aspects of the disclosure are initially described in the context of wireless communication systems. Additionally, aspects of the disclosure are illustrated by and described with reference to directional communication diagrams, a signaling diagram, and a process flow. Aspects of the disclosure are further illustrated by and described with reference to apparatus diagrams, system diagrams, and flowcharts that relate to multi-port reference signal resource configuration for high rank MIMO systems.

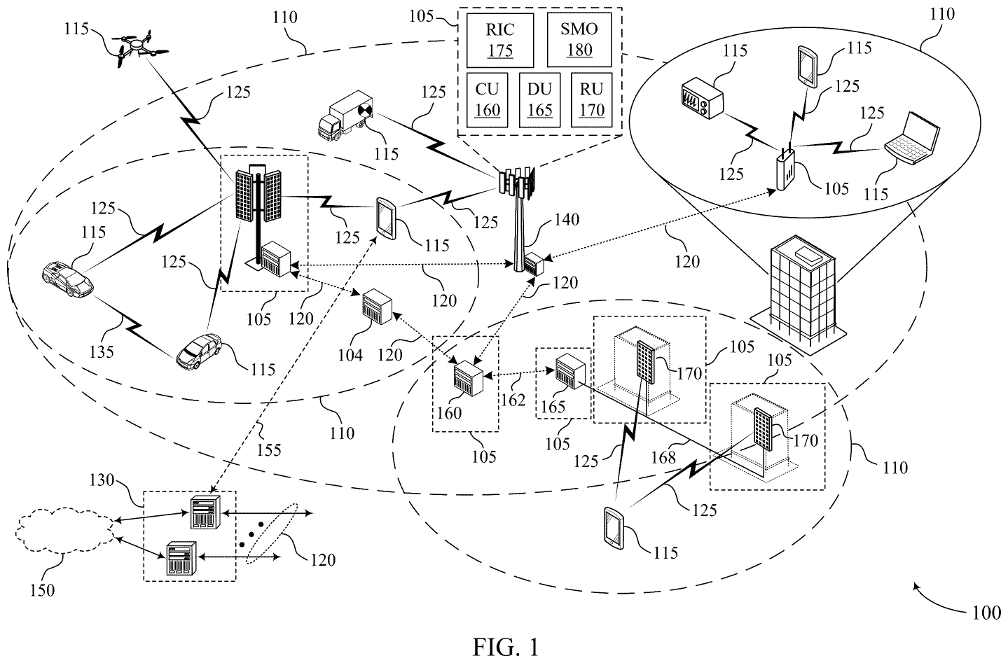

FIG. 1 shows an example of a wireless communication system 100 that supports multi-port reference signal resource configuration for high rank MIMO systems in accordance with one or more aspects of the present disclosure. The wireless communication system 100 may include one or more devices, such as one or more network devices (e.g., network entities 105), one or more UEs 115, and a core network 130. In some examples, the wireless communication system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communication system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communication system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communication with various types of devices in the wireless communication system 100 (e.g., other wireless communication devices, including UEs 115 or network entities 105), as shown in FIG. 1.

As described herein, a node of the wireless communication system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communication systems (e.g., the wireless communication system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communication with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communication (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communication resource may refer to a combination of an RF spectrum resource, a time resource, and a spatial resource (e.g., a spatial layer, a beam), and the use of multiple spatial resources may increase the data rate or data integrity for communication with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communication resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communication systems, such as the wireless communication system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., a quantity of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communication system 100 may include, for example, a heterogeneous network in which different types of the network entities 105 support communication for coverage areas 110 (e.g., different coverage areas) using the same or different RATs.

The wireless communication system 100 may be configured to support ultra-reliable communication or low-latency communication, or various combinations thereof. For example, the wireless communication system 100 may be configured to support ultra-reliable low-latency communication (URLLC). The UEs 115 may be designed to support ultra-reliable, low-latency, or critical functions. Ultra-reliable communication may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communication may be within the coverage area 110 of a network entity 105 (e.g., a base station 140, an RU 170), which may support aspects of such D2D communication being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communication may support a one-to-many (1:M) system in which each UE 115 transmits to one or more of the UEs 115 in the group. In some examples, a network entity 105 may facilitate the scheduling of resources for D2D communication. In some other examples, D2D communication may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communication system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communication using UHF waves may be associated with smaller antennas and shorter ranges (e.g., less than one hundred kilometers) compared to communication using the smaller frequencies and longer waves of the high frequency (HF) or very high frequency (VHF) portion of the spectrum below 300 MHz.

The wireless communication system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communication system 100 may support millimeter wave (mmW) communication between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed RF spectrum bands. For example, the wireless communication system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communication, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communication with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communication to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communication with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In accordance with some example implementations, a UE 115 and a network entity 105 (or any other of various wireless communication devices of the wireless communication system 100) may support one or more signaling- or configuration-based mechanisms associated with a multi-port CSI configuration for beam management. To support such a multi-port CSI configuration for beam management, the network entity 105 may configure a reference signal resource setting (e.g., a CSI-RS resource setting) indicating at least one reference signal resource set that includes at least one reference signal resource associated with a quantity of K>2 ports. Further, to facilitate feedback from the UE 115 associated with such a multi-port CSI configuration for beam management, the network entity 105 may configure a report quantity associated with a single reference signal resource indicator (e.g., a single CRI) and multiple measurement metrics. The UE 115, in accordance with being configured with the reference signal resource setting and the report quantity, may perform one or more reference signal (e.g., CSI-RS) measurements and feedback a report associated with the reference signal measurements.

In some aspects, the UE 115 may transmit a report indicating a reference signal resource indicator (e.g., a selected CRI) and multiple measurement metrics associated with the CRI. In such aspects, the reference signal resource indicator may correspond to a reference signal resource associated with a quantity of K>2 ports and the multiple measurement metrics may include a quantity of M≤K measurement metrics. In some examples, M may be associated with or otherwise indicative of a rank hypothesis associated with the reported/indicated reference signal resource, and may be associated with K, a quantity of N≤K QCL reference signals associated with the reference signal resource, or indicated via the reference signal resource setting. As used herein, a “measurement metric” may refer to or may otherwise be understood as an RSRP-equivalent metric, such as an RSRP metric, an SINR metric, or a CQI metric, among other examples.

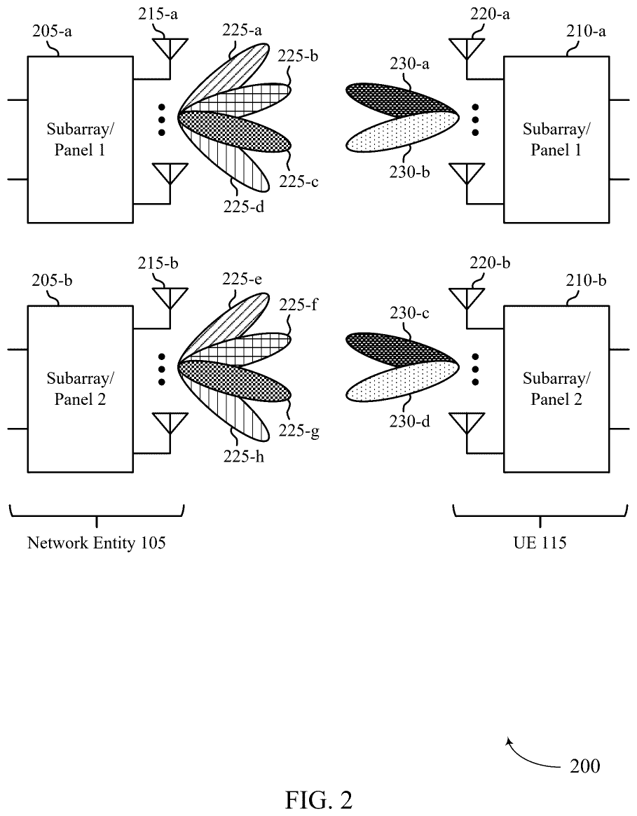

FIG. 2 shows an example of a directional communication diagram 200 that supports multi-port reference signal resource configuration for high rank MIMO systems in accordance with one or more aspects of the present disclosure. The directional communication diagram 200 may implement or be implemented to realize one or more aspects of the wireless communication system 100. For example, a UE 115 and a network entity 105, or any other wireless communication devices of the wireless communication system 100, may leverage the directional communication diagram 200 as part of a beam selection process (e.g., as part of a beam management procedure). In other words, the UE 115 and the network entity 105 may support beamforming (e.g., analog beamforming, digital beamforming, or hybrid beamforming) and may use the directional communication diagram 200 to select one or more (transmit or receive) beams (e.g., configurations associated with directional communication) for communication.

In the example of the directional communication diagram 200, the network entity 105 may support (e.g., use or employ) an antenna panel 205-a and an antenna panel 205-b. The antenna panels 205-a and the antenna panel 205-b may be equivalently referred to herein as antenna arrays or antenna sub-arrays. Further, although illustrated as supporting two antenna panels (e.g., the antenna panel 205-a and the antenna panel 205-b), the network entity 105 may support any quantity of antenna panels without exceeding the scope of the present disclosure. The network entity 105 may form (e.g., create or generate) one or more directional beams using one or more antennas of one or both of the antenna panel 205-a and the antenna panel 205-b. For example, the network entity 105 may form one or more of a directional beam 225-a, a directional beam 225-b, a directional beam 225-c, or a directional beam 225-d via one or more antennas 215-a of the antenna panel 205-a. Additionally, or alternatively, the network entity 105 may form one or more of a directional beam 225-e, a directional beam 225-f, a directional beam 225-g, or a directional beam 225-h via one or more antennas 215-b of the antenna panel 205-b.

Further, the UE 115 may support (e.g., use or employ) an antenna panel 210-a and an antenna panel 210-b. The antenna panels 210-a and the antenna panel 210-b may be equivalently referred to herein as antenna arrays or antenna sub-arrays. Further, although illustrated as supporting two antenna panels (e.g., the antenna panel 210-a and the antenna panel 210-b), the UE 115 may support any quantity of antenna panels without exceeding the scope of the present disclosure. In some aspects, two cross-polarized panels at the transmit and receive sides may support up to a rank of four for the UE 115. The UE 115 may form (e.g., create or generate) one or more directional beams using one or more antennas of one or both of the antenna panel 210-a and the antenna panel 210-b. For example, the UE 115 may form one or more of a directional beam 230-a or a directional beam 230-b via one or more antennas 220-a of the antenna panel 210-a. Additionally, or alternatively, the UE 115 may form one or more of a directional beam 230-c or a directional beam 230-d via one or more antennas 220-b of the antenna panel 210-b.

In some deployment scenarios (e.g., scenarios of high carrier frequency), the UE 115 and the network entity 105 may support analog beam-dominant hybrid beamforming, such as to counter the adverse impacts of pathloss. Further, in some systems, supporting a rank greater than two SU-MIMO may (automatically) mean or involve having more than one cross-polarized panel at the transmit and receive sides, as each panel may support up to rank-2 MIMO via up to two ports. This may be especially the case in FR2 and other high carrier frequency bands that rely heavily on analog beamforming to counter pathloss.

The UE 115 may employ a beam selection mechanism associated with selecting beams for the antenna panel 210-a and the antenna panel 210-b (or, more generally, for the different antenna panels at the UE 115) for supporting 2+ rank MIMO for the UE 115. If a same beam is used at each antenna panel, the UE 115 may experience a low rank condition for the beamformed channel. In other words, if a same beam is used, such a same beam may lead to a low rank condition for the beamformed channel.

Further, some beam management procedures may be followed by CSI acquisition, which may not be suitable for supporting some communication, including high rank SU-MIMO communication. For example, some beam management procedures may be mainly designed to address a poor receive SNR issue, and may thus be prioritized before a CSI framework in some systems. In such examples, such beam management may restrict the MIMO channel into a “dominant” subspace in the available dimension. In other words, by initially selecting one or more (candidate) beams in accordance with one or more SNR measurements (and prior to CSI acquisition), some non-selected beams may no longer be considered by one or both of the UE 115 or the network entity 105, which may preclude them from selection (even if, later on, such beams would be found to be especially suitable in terms of CSI or spatial diversity). Thus, some beam management procedures may “restrict” the MIMO channel by way of limiting which beams are selectable prior to CSI acquisition, which may be an impactful component in beam selection for some communication, including high rank SU-MIMO communication.

Additionally, or alternatively, some beam management procedures may define a mechanism according to which transmit-receive (Tx-Rx) beam pairs are selected individually based on RSRP/SINR. For example, although some systems may support a mechanism according to which the network entity 105 may configure the UE 115 to feedback multiple CRIs and associated L1 report quantities for each CRI in a single report, such a mechanism may be unable to check for a correlation between the multiple reported CRIs (e.g., a correlation between the associated/corresponding beams) or may not be able to accurately account for (e.g., measure) an interaction between the multiple reported CRIs (e.g., an interaction between the associated/corresponding beams).

In some systems, the network entity 105 may configure the UE 115 to feedback multiple CRIs and associated L1 report quantities for each CRI in a single report via one of multiple (e.g., two) options (e.g., as part of, for example, a 5G beam management framework). In accordance with a first option, the network entity 105 may indicate a nrofReportedRS>1 and may set groupBasedBeamReporting to ‘disabled’ in an RRC configuration. In accordance with such a first option, the UE 115 may report nrofReportedRS different CRIs or synchronization signal block (SSB) resource indicators (SSBRIs) in a same (e.g., single) report. In accordance with a second option, the network entity 105 may set groupBasedBeamReporting to ‘enabled’ in the RRC configuration. In accordance with such a second option, the UE 115 may report nrofReportedGroups of two CRIs or SSBRIs, selecting one resource from each of the two configured resource sets, with resources of each group being received simultaneously at the UE 115. In other words (in accordance with such group-based reporting), the UE 115 may be constrained to report back resources that can be simultaneously received by the UE 115. Each CRI or SSBRI may refer to a reference signal resource transmitted with a distinct transmit beam and an associated QCL-typeD (receive beam) reference. In some aspects, an exact transmit beam or associated QCL-typeD reference may vary in accordance with system implementation and configuration.

In both options, an L1 report quantity may be an RSRP or an SINR metric. The UE 115 may use an RSRP-based beam selection to select two distinct transmit beams that give the two highest RSRP metrics. Such an RSRP-based beam selection may not account for any correlation between the two distinct transmit beams. In other words, the UE 115 may not check to see whether the two beams are correlated or not. Further, reporting multiple RSRP (e.g., one for each receive (Rx) port) or averaging RSRP over all ports may be an option, but may still not characterize the cross-beam interaction. The UE 115 may use an SINR-based beam selection to select two distinct transmit beams that give the two highest SINR metrics. Such an SINR-based beam selection may not accurately or correctly account for an interaction between the two transmit beams. For example, the UE 115 may compute (e.g., measure) an L1-SINR for each of the two transmit beams individually with respect to a respective interference measurement resource (IMR) of that transmit beam (with IMRs for the two transmit beams being pre-configured and not dynamically adaptable).

In accordance with a baseline beam management procedure, if the network entity 105 supports four possible beams (e.g., beam directions) per transmit panel (per each of the antenna panel 205-a and the antenna panel 205-b) and the UE 115 supports two possible beams (e.g., beam direction) per receive panel (per each of the antenna panel 210-a and the antenna panel 210-b), via some additional signaling and processing at the UE 115, a combination of beams may be determined using sequential measurements. For example, for a transmit beam i with repetition enabled, the UE 115 may measure the transmit beam i with receive beam combinations of {directional beam 230-a, directional beam 230-c}, {directional beam 230-a, directional beam 230-d}, directional beam 230-b, directional beam 230-c}, and {directional beam 230-b, directional beam 230-d} during measurement epochs of tᵢ₁, tᵢ₂, tᵢ₃, and tᵢ₄, where i=1, 2, . . . , 8. Such a measurement sequence may be associated with a total of 4×8=32 individual measurements, based on which the UE 115 may determine a transmit beam pair (i, j) and the associated receive beams. Based on the report from the UE 115, the network entity 105 may configure a new CSI-RS resource that is transmitted with the transmit beam pair (i, j).

In accordance with the beam combination being determined based on separate individual (and sequential) measurements at the UE 115, there may be a performance loss for coherent transmission. For example, the UE 115 or the network entity 105 may determine the beams based on Equation 1, shown below, while a relatively more suitable (e.g., accurate) beam determination should have been determined based on Equation 2, also shown below. In some aspects, such a mismatch may occur due to non-coherent transmission from the different panels, involving separate RF chains and hardware components. In accordance with such a mismatch, reported beams or a reported beam group may still be rank deficient, which may be determined later (and potentially much later) during CSI acquisition. In other words, in some systems, the UE 115 may not select beams based on how correlated the beams are or based on a rank condition.

$$[ \begin{matrix}{w}_{a}^{*} {\check{H}}_{1 , 1} {f}_{1} & {w}_{a}^{*} {\check{H}}_{1 , 2} {f}_{5} \\ {w}_{c}^{*} {\check{H}}_{2 , 1} {f}_{1} & {w}_{c}^{*} {\check{H}}_{2 , 2} {f}_{5}\end{matrix} ] \qquad ( 1 )$$

$$[ \begin{matrix}{w}_{a}^{*} {H}_{1 , 1} {f}_{2} & {w}_{a}^{*} {H}_{1 , 2} {f}_{6} \\ {w}_{d}^{*} {H}_{2 , 1} {f}_{2} & {w}_{d}^{*} {H}_{2 , 2} {f}_{6}\end{matrix} ] \qquad ( 2 )$$

As used in Equations 1 and 2, H may generally refer to a channel, w may generally refer to a receive beam (e.g., as an analog beamforming weighting), and f may generally refer to a transmit beam (e.g., as an analog beamforming weighting). In some aspects, H_{i,j} may more specifically refer to a channel between an i^{th} receive panel and a j^{th} transmit panel. For example, H_{1,2} may refer to a channel between a 1^{st} receive panel (e.g., the antenna panel 210-a) and a 2^{nd} transmit panel (e.g., the antenna panel 205-b). In some aspects, wᵢ may more specifically refer to a receive beam i formed from a given receive panel. For example, wₐ may refer to the directional beam 230-a. In some aspects, fᵢ may more specifically refer to a transmit beam i formed from a given transmit panel. For example, f₁ may refer to the directional beam 225-a. In an example, wₐ*H_{1,1}f₂ may be a 2×2 matrix representative of the effective channel of a reference signal transmitted by the network entity 105 via the directional beam 225-b at the antenna panel 205-a and received by the UE 115 via the directional beam 230-a at the antenna panel 210-a.

In accordance with such a baseline beam management procedure, the network entity 105 may configure a new CSI-RS resource with multiple ports/beams and may request for CSI associated with the CSI-RS resource. In other words, in a group-based beam reporting, because the reported beam group can be simultaneously received by the UE 115, any CRI of the reported group (determined based on the L1 report) may be re-used as the source typeD reference signal for the new CSI-RS resource during the CSI stage. However, such a re-use may not be the case for multi-port CSI-RS based L1 reporting. In accordance with such a configuration, the UE 115 may report one or more of a rank indication (RI), a layer indication (LI), a precoding matrix indicator (PMI), a CQI, or other report quantities that are conditioned on the reported CRI. In some systems, a CRI may not be reported by the UE 115 if a codebooktype is set to Type II for PMI feedback. Further, if repetition is set to ‘on,’ CRI may not be reported in some systems. For example, in some systems, repetition may be limited to being enabled if (e.g., only if) the report quantity is set to RSRP or SINR or ‘none’ (P3). Additionally, in some systems, a CRI reported during beam management stage may sometimes have one or two ports, whereas a CRI used for CSI may sometimes have a relatively larger quantity of ports. For example, for L1 reporting, a CSI-RS resource may be limited to one or two ports. In some aspects, such a CSI-RS resource with multiple ports/beams may have a co-phasing issue and a mismatched calibration across ports, for which the UE 115 may be unable to account.

In accordance with some example implementations, the UE 115 and the network entity 105 may support a multi-port CSI configuration for beam management, which the UE 115 and the network entity 105 may employ to avoid a mismatch or calibration issue. Further, to avoid such a mismatch or calibration issue, the UE 115 and the network entity 105 may participate in communication to facilitate measurement and selection of beams jointly, for example, by simultaneously involving multiple transmit-receive (Tx-Rx) panels. For example, the network entity 105 may configure a reference signal resource setting (e.g., a CSI-RS resource setting) indicating at least one reference signal resource set that includes at least one reference signal resource associated with a quantity K>2 ports. Further, to facilitate feedback from the UE 115 associated with such a multi-port CSI configuration for beam management, the network entity 105 may configure a report quantity associated with a single reference signal resource indicator (e.g., a single CRI) and multiple measurement metrics. The UE 115, in accordance with being configured with the reference signal resource setting and the report quantity, may perform one or more reference signal (e.g., CSI-RS) measurements and feedback a report associated with the reference signal measurements.

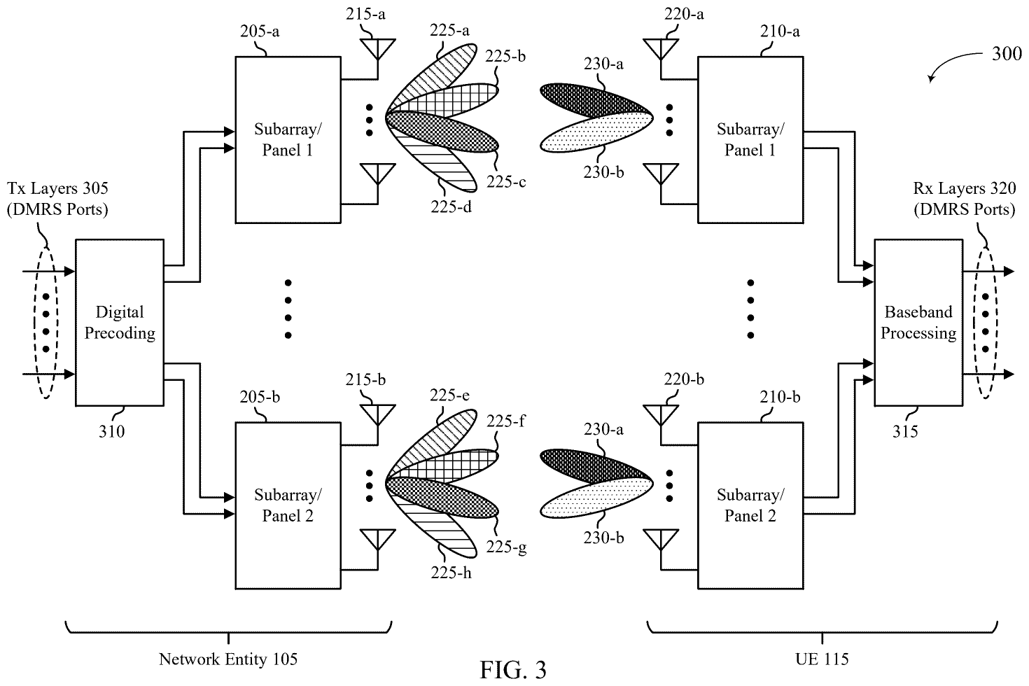

FIG. 3 shows an example of a directional communication diagram 300 that supports multi-port reference signal resource configuration for high rank MIMO systems in accordance with one or more aspects of the present disclosure. The directional communication diagram 300 may implement or be implemented to realize one or more aspects of the wireless communication system 100 or the directional communication diagram 200. For example, a UE 115 and a network entity 105, or any other wireless communication devices of the wireless communication system 100, may leverage the directional communication diagram 300 as part of a beam selection process (e.g., as part of a beam management procedure). In other words, the UE 115 and the network entity 105 may support beamforming (e.g., analog beamforming, digital beamforming, or hybrid beamforming) and may use the directional communication diagram 300 to select one or more (transmit or receive) beams (e.g., configurations associated with directional communication) for communication.

In the example of the directional communication diagram 300, the network entity 105 may input a set of transmit (Tx) layers 305 into a digital precoding 310, and may provide one or more outputs of the digital precoding 310 to a set of one or more antenna panels (including, for example, the antenna panel 205-a and the antenna panel 205-b). Accordingly, in some aspects, the directional communication diagram 300 may illustrate an example of at least digital precoding (in addition to, or as an alternative of, analog beamforming). In some aspects, directional communication diagram 300 may illustrate an example of hybrid beamforming (e.g., a combination of digital and analog beamforming). The UE 115 may obtain RF signaling via one or more antennas of a set of one or more antenna panels (including, for example, the antenna panel 210-a and the antenna panel 210-b) and may provide the RF signaling to a baseband processing 315. The UE 115 may obtain, as an output of the baseband processing 315, a set of receive (Rx) layers 320.

In some aspects, the set of transmit layers 305 may include a quantity Nₛ transmit layers 305. In such aspects, the set of receive layers 320 may include a quantity Nₛ receive layers 320. Further, in some aspects, the set of transmit layers 305 and the set of receive layers 320 may each be associated with or otherwise referred to as a set or quantity of DMRS ports. As described herein, a “port” may be understood or referred to as an antenna port or a DMRS port.

The digital precoding 310, which may be equivalently referred to as beamforming, may be associated with a precoding or transmit beam matrix F_{RF}. The matrix F_{RF} may be defined such that F_{RF}=blkdiag[f₁ f₂ . . . f_{L}_{_{T}}], where a first antenna panel of the network entity 105 may be associated with a beam f₁, a second antenna panel of the network entity 105 may be associated with a beam f₂, and an L_{T}^{th} antenna panel of the network entity 105 may be associated with a beam f_{L}_{_{T}}. In some aspects, each of f₁, f₂, and so on may refer to or be associated with (e.g., create, form, or generate) a respective (analog) transmit beam from the network entity 105. Accordingly, F_{RF} may be understood as including multiple beams. In some aspects, the digital precoding 310 may also be associated with a precoding matrix F_{BBS}[k]. Generally, a multi-beam transmit configuration provided by the network entity 105 may be defined in accordance with Equation 3, shown below.

$${f}_{j} ∈ {𝒞}_{TX CB} = \{ {f}_{R F , 1} , {f}_{R F , 2} … , {f}_{RF , {\dot{K}}_{T}} \} \qquad ( 3 )$$

The baseband processing 315 may be associated with a receive beam matrix W_{RF}. The matrix W_{RF} may be defined such that W_{RF}=blkdiag[w₁ w₂ . . . w_{L}_{_{R}}], where a first antenna panel of the UE 115 may be associated with a beam w₁, a second antenna panel of the UE 115 may be associated with a beam w₂, and an L_{R}^{th} antenna panel of the UE 115 may be associated with a beam w_{L}_{_{T}}. In some aspects, each of w₁, w₂, and so on may refer to or be associated with (e.g., create, form, or generate) a respective (analog) receive beam from the UE 115. Accordingly, W_{RF} may be understood as including multiple beams. In some aspects, the baseband processing 315 may also be associated with a matrix W_{BBS}[k]. Generally, a multi-beam receive configuration provided by the UE 115 may be defined in accordance with Equation 4, shown below.

$${w}_{i} ∈ {𝒞}_{R X C B} = \{ {w}_{RF , 1} , {w}_{R F , 2} … , {w}_{RF , {\dot{K}}_{R}} \} \qquad ( 4 )$$

In some implementations, one or both of the UE 115 or the network entity 105 may support a mechanism to jointly determine F_{RF} and W_{RF} (in accordance with, for example, an analog beamforming) and associated CSI (e.g., digital precoder via PMI) with low overhead to enable MIMO operation, such as MIMO operation in relatively large array hybrid systems. In some examples, the UE 115 or the network entity 105, or both, may extend such a mechanism to multiple panels/ports (e.g., multiple number of panels/ports) at the transmit and receive sides.

To determine an F_{RF} and an W_{RF} that provide a greatest or suitable performance (e.g., a greatest or sufficient reliability or throughput), the UE 115 and the network entity 105 may support multi-port CSI-RS-based L1 reporting with repetition set to ‘on’ in the CSI-RS resource set configuration. Further, in some aspects, the UE 115 and the network entity 105 may support multiple QCL-typeD configurations for a multi-port CSI-RS for L1 reporting, as F_{RF} and an associated W_{RF} may be based on multiple transmit and receive beams, respectively. Additionally, in some implementations, the UE 115 and the network entity 105 may support a measurement metric reporting mechanism to more accurately characterize a cross-beam interaction or correlation.

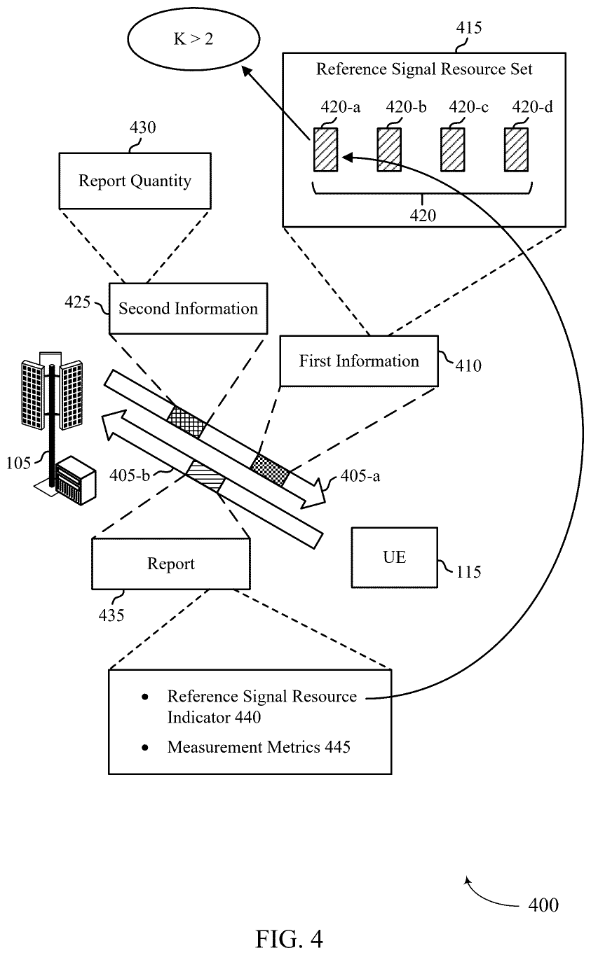

FIG. 4 shows an example of a signaling diagram 400 that supports multi-port reference signal resource configuration for high rank MIMO systems in accordance with one or more aspects of the present disclosure. The signaling diagram 400 may implement or be implemented to realize one or more aspects of the wireless communication system 100, the directional communication diagram 200, and the directional communication diagram 300. For example, the signaling diagram 400 illustrates communication between a UE 115 and a network entity 105, which may be examples of corresponding devices as illustrated and described herein, including by and with reference to FIGS. 1-3. The UE 115 and the network entity 105 may communicate (e.g., transmit or receive) via a downlink 405-a from the network entity 105 to the UE 115 and via an uplink 405-b from the UE 115 to the network entity 105.

In some implementations, the UE 115 and the network entity 105 may support one or more signaling- or configuration-based mechanisms associated with a multi-port CSI configuration for beam management. In some aspects, such mechanisms may include or be associated with a transmission of first information 410 and second information 425 from the network entity 105 to the UE 115. The first information 410 may be indicative of at least a reference signal resource set 415 that includes a set of reference signal resources 420. In the example of the signaling diagram 400, the set of reference signal resources 420 may include a reference signal resource 420-a, a reference signal resource 420-b, a reference signal resource 420-c, and a reference signal resource 420-d. Although illustrated and described in the example of the set of reference signal resources 420 including four reference signal resources 420, the set of reference signal resources 420 may include any quantity of reference signal resources 420 without exceeding the scope of the present disclosure.

The set of reference signal resources 420 may be CSI-RS resources, SSB resources, or any other set of one or more time-frequency locations via which a reference signal may be transmitted or received. For example, the reference signal resource set 415 may be a CSI-RS resource set. In some implementations, at least one reference signal resource 420, such as the reference signal resource 420-a, may be associated with a quantity K>2 of ports. For example, K may be equal to three, four, or five, among other examples. In other words, the reference signal resource 420-a may be associated with a particular F_{RF}. Additionally, or alternatively, K may be defined such that K≥2. Alternatively, K<2. In some implementations, the first information 410 (e.g., a resource configuration) may have, include, or otherwise be associated with one or more reference signal resource sets 415 with repetition enabled. In such implementations, the set of reference signal resources 420 may be associated with repetition (such that the UE 115 may measure different instances of each reference signal resource 420 with different receive beam combinations at the UE 115).

The second information 425 may be indicative of a report quantity 430 associated with at least the reference signal resource set 415. In some implementations, the report quantity 430 may be associated with a single reference signal resource indicator 440 (e.g., a single CRI) and a set of multiple measurement metrics 445 (e.g., two or more measurement metrics or values, such as two or more RSRP metrics or values, SINR metrics, CQI metrics or values, or any other RSRP-equivalent metrics or values). For example, the network entity 105, via the second information 425, may configure a report quantity 430 including or otherwise associated with one CRI and multiple measurement metrics 445. In some examples, the network entity 105 may also configure a wideband precoder assumption for a given rank hypothesis. In examples in which a measurement metric 445 is a CQI metric, the UE 115 may assume (e.g., determine) a wideband PMI as a diagonal matrix diag (v₁, . . . , v_{M}). In such examples, a value vᵢ may be based on a (known, computed, or stored) finite codebook configuration that is explicated indicated by the network entity 105 or that is in accordance with a network specification (and, for example, retrieved from one or more respective memories of the UE 115 and the network entity 105). Additionally, or alternatively, vᵢ may be determined (e.g., calculated, identified, or selected) by the UE 115 or the network entity 105 based on a quantity of the multiple measurement metrics 445 or a rank hypothesis in accordance with a rule (e.g., a rule specified by a network specification), with such a quantity of the multiple measurement metrics 445 or the rank hypothesis being denoted as M.

In accordance with the first information 410 and the second information 425, the UE 115 may measure one or more reference signals transmitted by the network entity 105 (e.g., via one or more of the reference signal resources 420). For example, the UE 115 may measure one or multiple RSRP metrics, SINR metrics, CQI metrics, or any combination thereof via each reference signal resource 420 of the set of reference signal resources 420. In some implementations, a quantity of the one or multiple metrics that the UE 115 may measure/compute for a given reference signal resource 420 may depend on a quantity of ports associated with that reference signal resource 420. The UE 115 may transmit a report 435 to the network entity 105, which may be a measurement report associated with a beam management procedure between the UE 115 and the network entity 105.

In some implementations, the report 435 may include an indication of a reference signal resource indicator 440 (e.g., a CRI or SSBRI, such as a single CRI or a single SSBRI) and multiple measurement metrics 445 associated with the reference signal resource indicator 440. For example, in some aspects, the reference signal resource indicator 440 may correspond to an index associated with the reference signal resource 420-a having K>2 ports and the UE 115 may report the multiple measurement metrics 445 associated with the reference signal resource 420-a having K>2 ports to convey information indicative of or otherwise associated with an interaction or correlation associated with the potentially multiple transmit beams associated with the reference signal resource 420-a.

A quantity of the multiple measurement metrics 445 may be associated with a rank hypothesis associated with the reference signal resource 420-a, such as a quantity of ports/layers/transmit beams associated with the reference signal resource 420-a. For example, the resource configuration (e.g., the first information 410) may indicate reference signal resources 420 with K>2 ports and the UE 115 may be expected to report M≤K measurement metrics, with M corresponding to the rank hypothesis. In some implementations, the first information 410 or the second information 425 (e.g., the resource configuration or the report configuration) may include an (explicit) indication of the rank hypothesis, such as via one or more bits or fields of one or more messages or information elements conveying the first information 410 or the second information 425. Additionally, or alternatively, the UE 115 or the network entity 105 may (implicitly) determine (e.g., calculate, identify, or select) the quantity M based on K. For example, in such implementations, the UE 115 or the network entity 105 may determine M in accordance with M=ƒ(K). The function ƒ may be a known function at the UE 115 and the network entity 105. In some aspects, the UE 115 and the network entity 105 may retrieve information indicative of the function ƒ from one or more respective memories. Additionally, or alternatively, the UE 115 and the network entity 105 may communicate (transmit or receive, via uplink or downlink signaling) information indicative of the function ƒ via over-the-air signaling.

In some implementations, the network entity 105 may provide (e.g., indicate) a set of N QCL-typeD reference signals for the K-port resources (e.g., for at least the reference signal resource 420-a associated with K>2 ports). In some implementations, N≤K. In accordance with the network entity 105 providing the set of N QCL-typeD reference signals for the K-port resources, the UE 115 or the network entity 105 may (implicitly) determine (e.g., calculate, identify, or select) M based on N. For example, the UE 115 or the network entity 105 may determine M in accordance with M=ƒ(N). The function ƒ may be a known function at the UE 115 and the network entity 105. In some aspects, the UE 115 and the network entity 105 may retrieve information indicative of the function ƒ from one or more respective memories. Additionally, or alternatively, the UE 115 and the network entity 105 may communicate (transmit or receive, via uplink or downlink signaling) information indicative of the function ƒ via over-the-air signaling.

In some examples, the network entity 105 may configure, via the first information 410, a CSI-RS resource setting to the UE 115 including N reference signal resource sets 415 (e.g., N CSI-RS resource sets) with repetition enabled, the N reference signal resource sets 415 having reference signal resources 420 each with K ports and specified (e.g., indicated) with a fixed rank hypothesis M (with M≤K). In such examples, each of the reference signal resource 420-a, the reference signal resource 420-b, the reference signal resource 420-c, and the reference signal resource 420-d may be associated with K ports. K may be greater than two and repetition may be enabled for at least one reference signal resource set 415 to facilitate receive beam refinement at the UE 115. Further, each reference signal resource 420 may have one, two, or up to K QCL-typeD reference signals indicated. In some aspects, the indicated/specified rank hypothesis M may be used as an implicit indication to the UE 115 that the resource configuration (e.g., as indicated, at least in part, by the first information 410) and the corresponding reporting (e.g., as indicated, at least in part, by the second information 425) is to facilitate high rank operation, such as high rank MIMO operation.

In such examples, the network entity 105 may configure (e.g., via the second information 425) the report quantity 430 to the UE 115 to feedback a reference signal resource indicator 440 (e.g., a selected CRI) and multiple measurement metrics 445 (e.g., multiple RSRP-equivalent metrics) in a same/single report 435. In other words, the UE 115 may feedback one report 435 that includes the reference signal resource indicator 440 (e.g., a single CRI) and the multiple measurement metrics 445, with the multiple measurement metrics 445 being associated with the reference signal resource 420-a indicated by the reference signal resource indicator 440. In some aspects, each measurement metric 445 of the multiple measurement metrics 445 may correspond to a respective MIMO layer (averaged over a bandwidth), based on the indicated rank hypothesis M. In other words, the multiple measurement metrics 445 may correspond to each MIMO layer (averaged over the bandwidth) based on the indicated rank hypothesis M. In some aspects, the UE 115 may additionally feedback (e.g., indicate) a precoder assumption as a wideband PMI along with a CQI either in the report 435 or via a second report. Such a second report may be a second part of the report 435. For example, the UE 115 may transmit the report 435 as a multi-part report and may include an indication of the precoder assumption as the wideband PMI via a second part (e.g., a part-2) or a third part (e.g., a part-3) of the multi-part report (with a first part, e.g., a part-1, of the multi-part report including the reference signal resource indicator 440 and the multiple measurement metrics 445).

In some other examples, the network entity 105 may configure, via the first information 410, a CSI-RS resource setting to the UE 115 including N reference signal resource sets 415 (e.g., N CSI-RS resource sets) with repetition enabled, the N reference signal resource sets 415 having reference signal resources 420 each with Kᵢ ports for 1<i<N, without specifying (e.g., indicating) a rank hypothesis M. For example, the first information 410 may indicate or set the rank hypothesis as ‘none.’ Kᵢ may be greater than two (for at least some reference signal resources 420). For example, the reference signal resource 420-a may be associated with a quantity of K₁ ports, the reference signal resource 420-b may be associated with a quantity of K₂ ports, the reference signal resource 420-c may be associated with a quantity of K₃ ports, and the reference signal resource 420-d may be associated with a quantity of K₄ ports. K₁, K₂, K₃, and K₄ may each be the same, may each be different, or some may be the same and some others may be different. In some aspects, at least K₁ may be greater than two. Further, repetition may be enabled for at least one reference signal resource set 415 to facilitate receive beam refinement at the UE 115.

In some implementations, the network entity 105 may include an indication, within or separate from the first information 410 or the second information 425, to indicate that the reporting requested from the UE 115 is to facilitate high rank operation, such as high rank MIMO operation. In some implementations, the first information 410 (e.g., the resource configuration) may be implicitly used by the UE 115 to perform a reporting (e.g., a reference signal measurement and a report generation) to facilitate high rank operation, such as high rank MIMO operation. In other words, the UE 115 may use the configuration itself to perform a reporting dedicated to facilitating high rank operation, such as high rank MIMO operation (without an explicit indication from the network entity 105 that the resource configuration is for facilitating high rank MIMO operation).

In such examples, the network entity 105 may configure (e.g., via the second information 425) the report quantity 430 to request or trigger the UE 115 to report a reference signal resource indicator 440 (e.g., a CRI), an RI, and multiple measurement metrics 445 (conditioned on the RI) within a same/single report 435. Generally, if the reference signal resource indicator 440 corresponds to a reference signal resource 420 as a resource i, the UE 115 may indicate an RI such that the indicated RI≤Kᵢ. For example, if the reference signal resource indicator 440 corresponds to the reference signal resource 420-a, the UE 115 may indicate an RI such that the indicated RI≤K₁. In some aspects, the multiple measurement metrics 445 may correspond to each MIMO layer (averaged over the bandwidth) based on the reported RI. In some aspects, the UE 115 may additionally feedback (e.g., indicate) a precoder assumption as a wideband PMI along with a CQI either in the report 435 or via a second report. Such a second report may be a second part of the report 435. For example, the UE 115 may transmit the report 435 as a multi-part report and may include an indication of the precoder assumption as the wideband PMI via a second part (e.g., a part-2) or a third part (e.g., a part-3) of the multi-part report (with a first part, e.g., a part-1, of the multi-part report including the reference signal resource indicator 440 and the multiple measurement metrics 445).

In some implementations, the network entity 105 may configure a new (e.g., updated or additional) resource configuration with the reported reference signal resource indicator 440 as a QCL-typeD reference signal based on the report 435 from the UE 115. For example, the network entity 105 may configure or establish a new resource, such as a channel measurement resource (CMR), that has the reference signal resource 420-a (the resource indicated by the reference signal resource indicator 440) as a QCL-typeD reference signal. In some aspects, UE 115 or the network entity 105 may derive the QCL source for (associated with) the different ports of such a new resource (e.g., such a new CMR) from the original reference signal configuration (e.g., the first information 410, which may be a CSI-RS configuration) and the reported wideband precoder assumption.

In some implementations, the network entity 105 may additionally indicate whether the UE 115 reported wideband precoder has been applied or not. The UE 115 may perform CSI reporting based on whether the network entity 105 indicates that the reported wideband precoder has been applied or not. In other words, based on the additional indication from the network entity 105, the UE 115 may perform CSI reporting differently. For example, the UE 115 may perform a first CSI reporting scheme if the reported wideband precoder has been applied and may perform a second CSI reporting scheme if the reported wideband precoder has not been applied.

Additionally, or alternatively, based on the report 435, the network entity 105 may request additional CSI (e.g., one or both of sub-band CSI or a CQI, among other examples). In some implementations, the network entity 105 may request additional CSI based on the report 435 without configuring or transmitting a new resource (e.g., without configuring, establishing, or generating a new CMR). In such implementations, the UE 115 may feedback previously computed and stored values based on receiving the request from the network entity 105. For example, the UE 115 may measure, compute, and store (e.g., buffer) one or more CSI values in accordance with measuring, for example, the reference signal resource 420-a and may provide such one or more CSI values to the network entity 105 (via a signaled report) upon request (e.g., in a second report sometime after transmission of the report 435).

In some aspects, the measurement metrics 445 may be defined based on, may be associated with, or may include a singular value decomposition (SVD) of an effective channel for each layer (e.g., for each MIMO layer at the UE 115, such as for each MIMO layer received/measured at the UE 115). In some aspects, such an SVD of the effective channel for each layer may be equivalently included, in the measurement metrics 445, as a wideband CQI associated with each layer. The effective channel may be denoted as H_{eff}, which the UE 115 or the network entity 105 may define such that H_{eff}=W_{RF}*HF_{RF}. In some aspects, the effective channel H_{eff} may be understood as the effective channel seen or measured in the baseband for a given combination of transmit and receive beams. In accordance with such a definition, measurement, or calculation of the measurement metrics 445 based on the SVD of the effective channel H_{eff}, a spectral efficiency SE may be given by Equation 5, shown below.

$$S E = {log}_{2} det ( 1 + \frac{S N R}{{N}_{s}} {H}_{eff} {H}_{eff}^{*} ) = {\sum }_{i} {log}_{2} ( 1 + {λ}_{i} ) . \qquad ( 5 )$$

In some implementations, the UE 115 or the network entity 105 may define the SVD of

$$\frac{S N R}{{N}_{s}}$$

H_{eff}H_{eff}* as UΛU, with Λ=diag(λ₁, . . . , λ_{N}_{ₛ}). In such implementations, the UE 115 and the network entity 105 may support a quantization and reporting format for the report 435 that is compatible with (e.g., the same as) an RSRP/SINR report that the UE 115 might otherwise transmit to provide RSRP/SINR metrics to the network entity 105, while also enabling the UE 115 to inform the network entity 105 if a combination of beams (associated with the reference signal resource 420-a indicated by the reference signal resource indicator 440) may be useful for high rank operation, such as high rank MIMO operation.

Further, in some aspects, the UE 115 and the network entity 105 may introduce a wideband precoder D=diag(v₁, . . . , v_{M}), using which a spectral efficiency SE may become a value given by Equation 6, shown below.

$$S E = {log}_{2} det ( 1 + S N R * {D}^{2} {H}_{eff} {H}_{eff}^{*} ) . \qquad ( 6 )$$

In accordance with such a wideband precoder D, an application of the precoder coefficients may scale a transmission by beam fᵢ by a factor vᵢ. In some aspects, such a scaling of a transmission by a given beam fᵢ may be useful in MIMO operation involving heterogeneous sub-arrays in which each antenna panel may have different transmission capabilities in terms of analog codebook or power amplifier (PA) configuration, among other examples. In some aspects, the UE 115 or the network entity 105 may configure the coefficients of the wideband precoder D based on a water-filling (e.g., a water-filling algorithm) by the receive node (e.g., the UE 115). In accordance with using the wideband precoder D, the UE 115 or the network entity 105 may calculate, identify, select, or otherwise determine a measurement metric 445 based on the SVD of SNR*D²H_{eff}H_{eff}*.

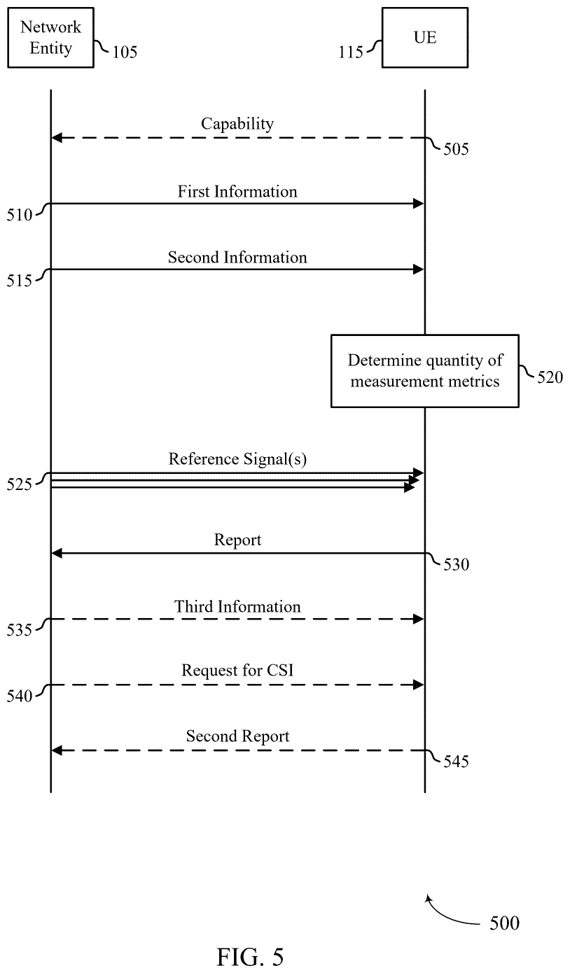

FIG. 5 shows an example of a process flow 500 that supports multi-port reference signal resource configuration for high rank MIMO systems in accordance with one or more aspects of the present disclosure. The process flow 500 may implement or be implemented to realize one or more aspects of the wireless communication system 100, the directional communication diagram 200, the directional communication diagram 300, and the signaling diagram 400. For example, the process flow 500 illustrates communication between a UE 115 and a network entity 105, which may be examples of corresponding devices as illustrated and described herein, including by and with reference to FIGS. 1-4.

Alternative examples of the following may be implemented. Some steps may be performed in a different order than described or may not be performed at all. In some implementations, steps may include additional features not mentioned below, or further steps may be added. Further, although example devices are shown performing the operations of the process flow 500, some aspects of some operations also may be performed by one or more other wireless communication devices without exceeding the scope of the present disclosure. For example, the network entity 105 may perform some aspects of some operations across multiple components, which may be disaggregated or collocated.

At 505, the UE 115 may transmit, to the network entity 105, an indication of a capability of the UE 115. For example, the UE 115 may transmit an indication that the UE 115 is capable of supporting one or more reference signal resources with a quantity of K>2 ports. In other words, the UE 115 may transmit an indication that the UE 115 is capable of supporting a multi-port CSI configuration for beam management. The UE 115 may transmit such an indication of the capability of the UE 115 via one or more of RRC signaling, one or more MAC control elements (MAC-CEs), or uplink control information (UCI).

At 510, the UE 115 may receive, from the network entity 105, first information 410 indicative of at least a first reference signal resource set 415. In some examples, the first reference signal resource set 415 may include a set of reference signal resources 420. The UE 115 may receive the first information 410 via RRC signaling (e.g., via one or more RRC information elements). In some implementations, the UE 115 may receive, via the first information 410, an indication that a repetition associated with the set of reference signal resources 420 is enabled. Additionally, or alternatively, the UE 115 may receive, via the first information 410, an indication of a rank hypothesis associated with the set of reference signal resources 420. Additionally, or alternatively, the UE 115 may receive, via the first information 410, an indication of a mode of operation for communication between the UE 115 and the network entity 105, the mode of operation referring to or indicating SU-MIMO operation with a rank greater than two.

Additionally, or alternatively, the UE 115 may receive, via the first information 410, an indication of a respective set of QCL reference signals (e.g., QCL-typeD reference signals) associated with each reference signal resource 420 of the set of reference signal resources 420. In some examples, a quantity N of the respective set of QCL reference signals associated with each reference signal resource 420 of the set of reference signal resources 420 is less than or equal to a respective quantity K of ports associated with that reference signal resource 420 of the set of reference signal resources 420 (e.g., N≤K).

Additionally, or alternatively, the UE 115 may receive, via the first information 410, an indication of same quantity of ports (e.g., K ports) associated with each reference signal resource 420 of the set of reference signal resources 420. In some examples, the same quantity of ports indicated/configured for each reference signal resource 420 may be greater than two (e.g., K>2). Additionally, or alternatively, the UE 115 may receive, via the first information 410, an indication of a respective quantity of ports (e.g., Kᵢ ports) associated with each reference signal resource 420 of the set of reference signal resources 420. In some aspects, at least one reference signal resource 420 (e.g., at least the reference signal resource 420-a) may be associated with a quantity of ports that is greater than two (e.g., for at least one i, Kᵢ>2).

At 515, the UE 115 may receive, from the network entity 105, second information 425 indicative of a report quantity 430 associated with at least the first reference signal resource set 415. The UE 115 may receive the second information 425 via RRC signaling (e.g., via one or more RRC information elements). In some examples, the report quantity 430 may be associated with a single reference signal resource indicator 440 (e.g., a single CRI) and a set of multiple measurement metrics 445. In some implementations, the UE 115 may receive, via the second information 425, an indication of a rank hypothesis associated with the set of reference signal resources 420. In some aspects, the indication of the rank hypothesis may indicate a mode of operation for communication between the UE 115 and the network entity 105. Such a mode of operation may be or include an SU-MIMO operation with a rank greater than two. Additionally, or alternatively, the UE 115 may receive, via the second information 425, an indication that the report quantity 430 is further associated with an RI.

At 520, the UE 115 (and, in some examples, the network entity 105) may determine a quantity of measurement metrics 445 (e.g., M) that the UE 115 may report to the network entity 105. In some examples, the quantity of measurement metrics 445 may be equal to a value a rank hypothesis associated with the set of reference signal resources 420 or a measured/calculated/selected rank hypothesis associated with a (to be) reported reference signal resource 420. Additionally, or alternatively, the quantity of measurement metrics 445 may be based on (e.g., equal to) a value of an RI indicated by the second information 425. In some examples, the quantity of the measurement metrics 445 may be less than or equal to a quantity of ports (e.g., K) associated with the reference signal resource 420 (e.g., M≤K).

In some implementations, the UE 115 (and, in some examples, the network entity 105) may determine the quantity of the measurement metrics 445 in accordance with a function, such as in accordance with M=ƒ(K). In such implementations, the UE 115 may input, into the function ƒ, the quantity K of ports associated with the reference signal resource 420 and may obtain, as an output of the function ƒ, the quantity M of the measurement metrics 445. Additionally, or alternatively, the quantity of the measurement metrics 445 may be based on a quantity of QCL reference signals associated with the reference signal resource 420.

At 525, the UE 115 may receive and measure one or more reference signals via the set of reference signal resources 420. For example, the network entity 105 may transmit one or more reference signals via each reference signal resource 420 of the set of reference signal resources 420 to facilitate measurement at the UE 115 across each of the reference signal resources 420. The UE 115 may obtain the multiple measurement metrics 445 in accordance with receiving and measuring the one or more reference signals. Such measurement metrics 445 may include one or more RSRP metrics, one or more SINR metrics, one or more CQI metrics, or any combination thereof. In some implementations, the UE 115 may buffer CSI (e.g., one or more CSI values) associated with one or more reference signal resources 420 in association with the measurement of the set of reference signal resources 420.

At 530, the UE 115 may transmit, to the network entity 105, a report 435. The UE 115 may transmit the report 435 in accordance with the report quantity 430. In some examples, the report 435 may include an indication of a first (e.g., single) reference signal resource indicator 440 associated with a reference signal resource 420 of the set of reference signal resources 420. In examples in which the reference signal resource 420 is associated with K>2 ports, the report 435 may further include multiple measurement metrics 445 associated with the reference signal resource 420. In some aspects, a quantity of the multiple measurement metrics 445 may be determined at 520. In some aspects, each measurement metric 445 of the multiple measurement metrics 445 may be associated with a respective MIMO layer at the UE 115. In some implementations, the UE 115 may transmit, via the report 435, an indication of a PMI and an indication of a CQI associated with the reference signal resource 420. In some other implementations, the UE 115 may transmit the indication of the PMI and the indication of the CQI associated with the reference signal resource 420 via a second report, such as a second report transmitted at 545. The UE 115 may transmit the report 435 via RRC signaling, one or more MAC-CEs, or UCI.

At 535, the UE 115 may receive, from the network entity 105, third information indicative of a CMR. The UE 115 may receive the third information via RRC signaling (e.g., via one or more RRC information elements). In some aspects, the third information may include an indication of the reported reference signal resource 420 as a QCL reference signal for the CMR in accordance with the report 435 sent at 530. In some implementations, the reported reference signal resource 420 may be associated with multiple (e.g., two or more) ports in accordance with the first information 410.

At 540, the UE 115 may receive, from the network entity 105, a request for CSI associated with the reported reference signal resource 420.

At 545, the UE 115 may transmit, to the network entity 105, a second report. In some implementations, the UE 115 may transmit the second report in accordance with the third information received at 535. In such implementations, the second report may include at least a portion of CSI associated with the CMR configured via the third information. Additionally, or alternatively, the UE 115 may transmit the second report in accordance with the request received at 540. In such implementations, the UE 115 may transmit the CSI associated with the reference signal resource 420 (e.g., that the UE 115 stored or buffered).

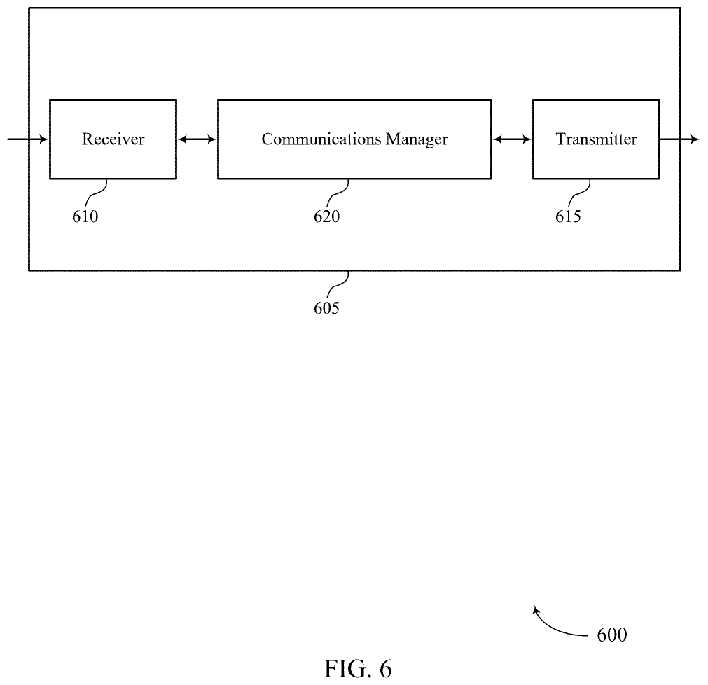

FIG. 6 shows a block diagram 600 of a device 605 that supports multi-port reference signal resource configuration for high rank MIMO systems in accordance with one or more aspects of the present disclosure. The device 605 may be an example of aspects of a UE 115 as described herein. The device 605 may include a receiver 610, a transmitter 615, and a communication manager 620. The device 605, or one or more components of the device 605 (e.g., the receiver 610, the transmitter 615, the communication manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to multi-port reference signal resource configuration for high rank MIMO systems). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to multi-port reference signal resource configuration for high rank MIMO systems). In some examples, the transmitter 615 may be co-located with a receiver 610 in a transceiver module. The transmitter 615 may utilize a single antenna or a set of multiple antennas.

The communication manager 620, the receiver 610, the transmitter 615, or various combinations or components thereof may be examples of means for performing various aspects of multi-port reference signal resource configuration for high rank MIMO systems as described herein. For example, the communication manager 620, the receiver 610, the transmitter 615, or various combinations or components thereof may be capable of performing one or more of the functions described herein.

In some examples, the communication manager 620, the receiver 610, the transmitter 615, or various combinations or components thereof may be implemented in hardware (e.g., in communication management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communication manager 620, the receiver 610, the transmitter 615, or various combinations or components thereof may be implemented in code (e.g., as communication management software or firmware) executed by at least one processor (e.g., referred to as a processor-executable code). If implemented in code executed by at least one processor, the functions of the communication manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communication manager 620 may be configured to perform various operations (e.g., receiving, obtaining, monitoring, outputting, transmitting) using or otherwise in cooperation with the receiver 610, the transmitter 615, or both. For example, the communication manager 620 may receive information from the receiver 610, send information to the transmitter 615, or be integrated in combination with the receiver 610, the transmitter 615, or both to obtain information, output information, or perform various other operations as described herein.

The communication manager 620 may support wireless communication in accordance with examples as disclosed herein. For example, the communication manager 620 is capable of, configured to, or operable to support a means for receiving first information indicative of at least a first reference signal resource set, the first reference signal resource set including a set of reference signal resources. The communication manager 620 is capable of, configured to, or operable to support a means for receiving second information indicative of a report quantity associated with at least the first reference signal resource set, where the report quantity is associated with a single reference signal resource indicator and a set of multiple measurement metrics. The communication manager 620 is capable of, configured to, or operable to support a means for transmitting, in accordance with the report quantity, a report including an indication of a first reference signal resource indicator associated with a reference signal resource of the set of reference signal resources and a first set of multiple measurement metrics associated with the reference signal resource of the set of reference signal resources.

By including or configuring the communication manager 620 in accordance with examples as described herein, the device 605 (e.g., at least one processor controlling or otherwise coupled with the receiver 610, the transmitter 615, the communication manager 620, or a combination thereof) may support techniques for reduced processing, reduced power consumption, and more efficient utilization of communication resources.

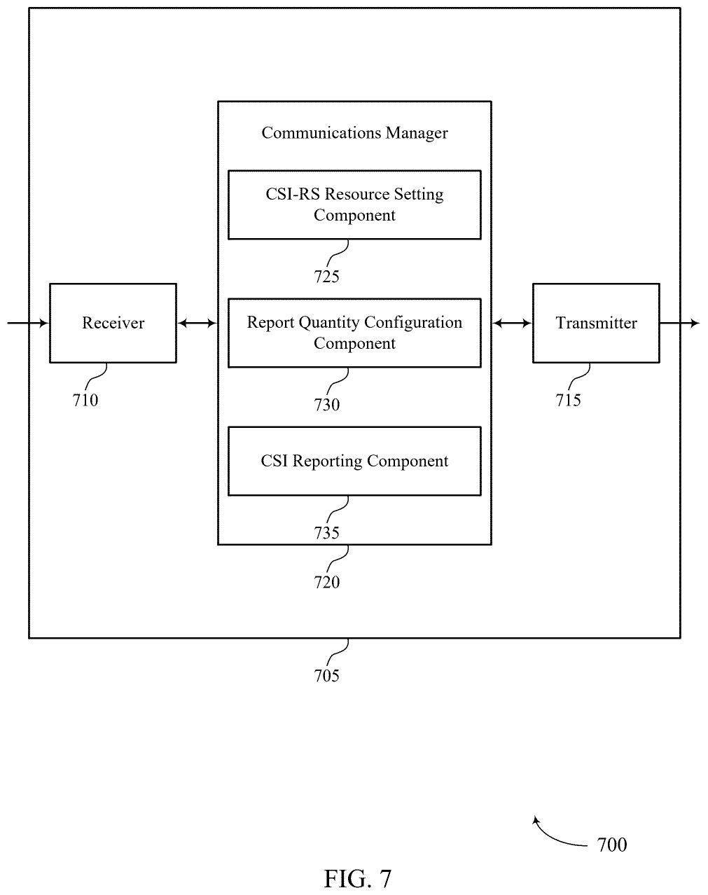

FIG. 7 shows a block diagram 700 of a device 705 that supports multi-port reference signal resource configuration for high rank MIMO systems in accordance with one or more aspects of the present disclosure. The device 705 may be an example of aspects of a device 605 or a UE 115 as described herein. The device 705 may include a receiver 710, a transmitter 715, and a communication manager 720. The device 705, or one or more components of the device 705 (e.g., the receiver 710, the transmitter 715, the communication manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to multi-port reference signal resource configuration for high rank MIMO systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to multi-port reference signal resource configuration for high rank MIMO systems). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of multi-port reference signal resource configuration for high rank MIMO systems as described herein. For example, the communication manager 720 may include a CSI-RS resource setting component 725, a report quantity configuration component 730, a CSI reporting component 735, or any combination thereof. The communication manager 720 may be an example of aspects of a communication manager 620 as described herein. In some examples, the communication manager 720, or various components thereof, may be configured to perform various operations (e.g., receiving, obtaining, monitoring, outputting, transmitting) using or otherwise in cooperation with the receiver 710, the transmitter 715, or both. For example, the communication manager 720 may receive information from the receiver 710, send information to the transmitter 715, or be integrated in combination with the receiver 710, the transmitter 715, or both to obtain information, output information, or perform various other operations as described herein.

The communication manager 720 may support wireless communication in accordance with examples as disclosed herein. The CSI-RS resource setting component 725 is capable of, configured to, or operable to support a means for receiving first information indicative of at least a first reference signal resource set, the first reference signal resource set including a set of reference signal resources. The report quantity configuration component 730 is capable of, configured to, or operable to support a means for receiving second information indicative of a report quantity associated with at least the first reference signal resource set, where the report quantity is associated with a single reference signal resource indicator and a set of multiple measurement metrics. The CSI reporting component 735 is capable of, configured to, or operable to support a means for transmitting, in accordance with the report quantity, a report including an indication of a first reference signal resource indicator associated with a reference signal resource of the set of reference signal resources and a first set of multiple measurement metrics associated with the reference signal resource of the set of reference signal resources.

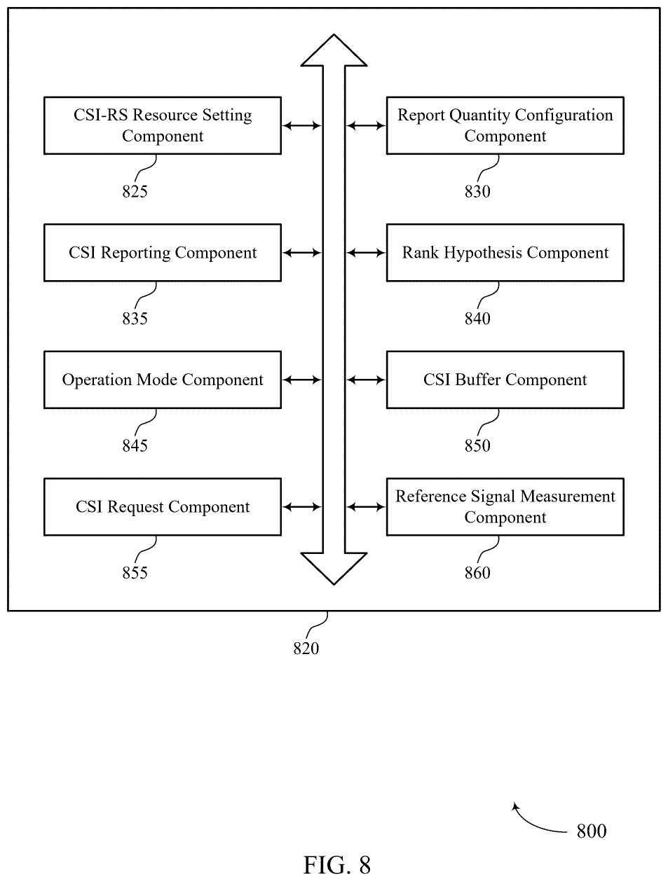

FIG. 8 shows a block diagram 800 of a communication manager 820 that supports multi-port reference signal resource configuration for high rank MIMO systems in accordance with one or more aspects of the present disclosure. The communication manager 820 may be an example of aspects of a communication manager 620, a communication manager 720, or both, as described herein. The communication manager 820, or various components thereof, may be an example of means for performing various aspects of multi-port reference signal resource configuration for high rank MIMO systems as described herein. For example, the communication manager 820 may include a CSI-RS resource setting component 825, a report quantity configuration component 830, a CSI reporting component 835, a rank hypothesis component 840, an operation mode component 845, a CSI buffer component 850, a CSI request component 855, a reference signal measurement component 860, or any combination thereof. Each of these components, or components or subcomponents thereof (e.g., one or more processors, one or more memories), may communicate, directly or indirectly, with one another (e.g., via one or more buses).

The communication manager 820 may support wireless communication in accordance with examples as disclosed herein. The CSI-RS resource setting component 825 is capable of, configured to, or operable to support a means for receiving first information indicative of at least a first reference signal resource set, the first reference signal resource set including a set of reference signal resources. The report quantity configuration component 830 is capable of, configured to, or operable to support a means for receiving second information indicative of a report quantity associated with at least the first reference signal resource set, where the report quantity is associated with a single reference signal resource indicator and a set of multiple measurement metrics. The CSI reporting component 835 is capable of, configured to, or operable to support a means for transmitting, in accordance with the report quantity, a report including an indication of a first reference signal resource indicator associated with a reference signal resource of the set of reference signal resources and a first set of multiple measurement metrics associated with the reference signal resource of the set of reference signal resources.

In some examples, the CSI-RS resource setting component 825 is capable of, configured to, or operable to support a means for receiving, via the first information, an indication that a repetition associated with the set of reference signal resources is enabled, where transmitting the report is in association with the repetition being enabled.

In some examples, the rank hypothesis component 840 is capable of, configured to, or operable to support a means for receiving, via the first information or the second information, an indication of a rank hypothesis associated with the set of reference signal resources, where a first quantity of the first set of multiple measurement metrics is equal to a value of the rank hypothesis.

In some examples, the first quantity of the first set of multiple measurement metrics is less than or equal to a second quantity of ports associated with the reference signal resource.

In some examples, the indication of the rank hypothesis indicates a mode of operation for communication between the UE and a network entity. In some examples, the mode of operation includes SU-MIMO operation with a rank greater than two. In some examples, transmitting the report is in accordance with the mode of operation.

In some examples, the operation mode component 845 is capable of, configured to, or operable to support a means for receiving, via the first information, an indication of a mode of operation for communication between the UE and a network entity, where the mode of operation includes SU-MIMO operation with a rank greater than two, and where transmitting the report is in accordance with the mode of operation.

In some examples, a first quantity of the first set of multiple measurement metrics is based on a second quantity of ports associated with the reference signal resource.

In some examples, the CSI reporting component 835 is capable of, configured to, or operable to support a means for inputting, into a function, the second quantity of ports associated with the reference signal resource. In some examples, the CSI reporting component 835 is capable of, configured to, or operable to support a means for obtaining, as an output of the function, the first quantity.

In some examples, the CSI-RS resource setting component 825 is capable of, configured to, or operable to support a means for receiving, via the first information, an indication of a respective set of QCL reference signals associated with each reference signal resource of the set of reference signal resources.

In some examples, a quantity of the respective set of QCL reference signals associated with each reference signal resource of the set of reference signal resources is less than or equal to a respective quantity of ports associated with that reference signal resource of the set of reference signal resources.

In some examples, the reference signal resource is associated with a set of multiple QCL reference signals of a second quantity. In some examples, a first quantity of the first set of multiple measurement metrics is based on the second quantity.

In some examples, the CSI-RS resource setting component 825 is capable of, configured to, or operable to support a means for receiving, via the first information, an indication of a same quantity of ports associated with each reference signal resource of the set of reference signal resources, where the same quantity of ports is greater than two.

In some examples, the CSI-RS resource setting component 825 is capable of, configured to, or operable to support a means for receiving, via the first information, an indication of a respective quantity of ports associated with each reference signal resource of the set of reference signal resources.

In some examples, the reference signal resource is associated with a first quantity of ports. In some examples, a second reference signal resource of the set of reference signal resources is associated with a second quantity of ports different than the first quantity of ports. In some examples, at least the first quantity of ports is greater than two.

In some examples, the CSI reporting component 835 is capable of, configured to, or operable to support a means for transmitting, via the report or a second report associated with the reference signal resource, an indication of a PMI and an indication of a CQI associated with the reference signal resource.

In some examples, the report quantity configuration component 830 is capable of, configured to, or operable to support a means for receiving, via the second information, an indication that the report quantity is further associated with an RI. In some examples, the CSI reporting component 835 is capable of, configured to, or operable to support a means for transmitting, via the report, a first RI associated with the reference signal resource, where a first quantity of the first set of multiple measurement metrics is equal to a value of the first RI.

In some examples, the value of the first RI is less than or equal to a second quantity of ports associated with the reference signal resource.

In some examples, each measurement metric of the first set of multiple measurement metrics is associated with a respective MIMO layer at the UE.

In some examples, the CSI-RS resource setting component 825 is capable of, configured to, or operable to support a means for receiving third information indicative of a CMR, where the third information includes an indication of the reference signal resource as a QCL reference signal for the CMR in accordance with the report, and where the reference signal resource is associated with a set of multiple ports in accordance with the first information.

In some examples, the CSI reporting component 835 is capable of, configured to, or operable to support a means for transmitting, in accordance with the third information, a second report including at least a portion of CSI associated with the CMR.

In some examples, the CSI buffer component 850 is capable of, configured to, or operable to support a means for buffering CSI associated with the reference signal resource in association with a measurement of the reference signal resource. In some examples, the CSI request component 855 is capable of, configured to, or operable to support a means for receiving a request for the CSI associated with the reference signal resource. In some examples, the CSI reporting component 835 is capable of, configured to, or operable to support a means for transmitting, in accordance with the request, a second report including the CSI associated with the reference signal resource.

In some examples, the first set of multiple measurement metrics are based on an SVD of an effective channel of each MIMO layer at the UE.

In some examples, the first set of multiple measurement metrics are further based on a wideband precoder. In some examples, the wideband precoder is associated with a set of multiple precoder coefficients. In some examples, each precoder coefficient of the set of multiple precoder coefficients is applied to a respective transmit beam associated with the reference signal resource.

In some examples, the reference signal measurement component 860 is capable of, configured to, or operable to support a means for measuring each reference signal resource of the set of reference signal resources in accordance with the report quantity, where transmitting the report is in association with measuring each reference signal resource of the set of reference signal resources.

In some examples, the first information is associated with a beam management between the UE and a network entity. In some examples, the first set of multiple measurement metrics includes a set of multiple RSRP metrics, a set of multiple SINR metrics, or a set of multiple CQI metrics.

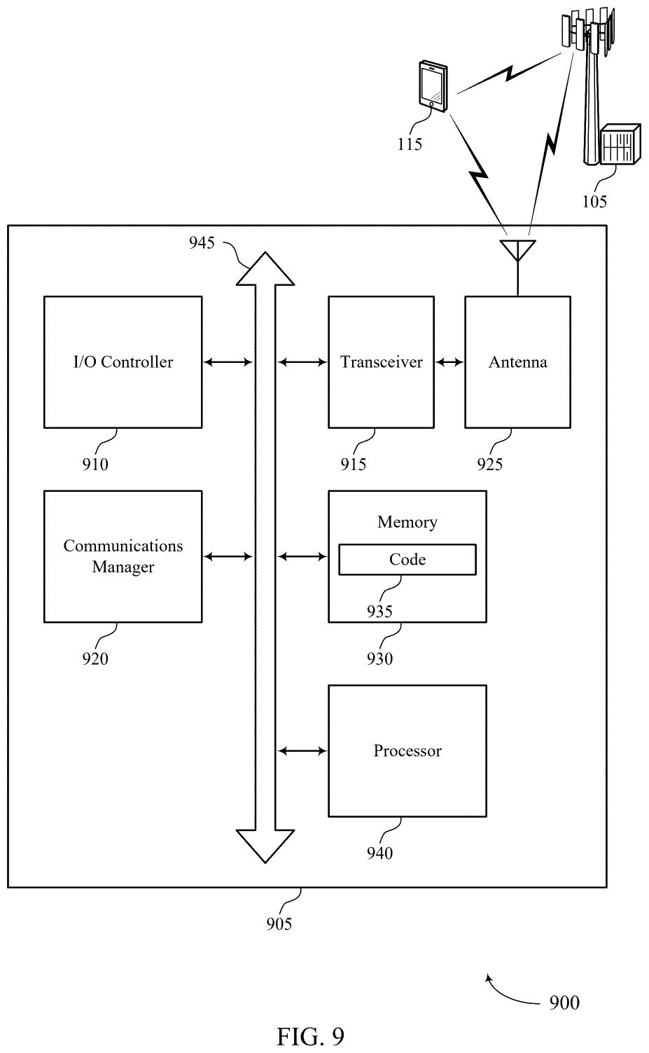

FIG. 9 shows a diagram of a system 900 including a device 905 that supports multi-port reference signal resource configuration for high rank MIMO systems in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communication including components for transmitting and receiving communication, such as a communication manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM), read-only memory (ROM), or any combination thereof. The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting multi-port reference signal resource configuration for high rank MIMO systems). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communication manager 920 may support wireless communication in accordance with examples as disclosed herein. For example, the communication manager 920 is capable of, configured to, or operable to support a means for receiving first information indicative of at least a first reference signal resource set, the first reference signal resource set including a set of reference signal resources. The communication manager 920 is capable of, configured to, or operable to support a means for receiving second information indicative of a report quantity associated with at least the first reference signal resource set, where the report quantity is associated with a single reference signal resource indicator and a set of multiple measurement metrics. The communication manager 920 is capable of, configured to, or operable to support a means for transmitting, in accordance with the report quantity, a report including an indication of a first reference signal resource indicator associated with a reference signal resource of the set of reference signal resources and a first set of multiple measurement metrics associated with the reference signal resource of the set of reference signal resources.

By including or configuring the communication manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communication manager 920 may be configured to perform various operations (e.g., receiving, monitoring, transmitting) using or otherwise in cooperation with the transceiver 915, the one or more antennas 925, or any combination thereof. Although the communication manager 920 is illustrated as a separate component, in some examples, one or more functions described with reference to the communication manager 920 may be supported by or performed by the at least one processor 940, the at least one memory 930, the code 935, or any combination thereof. For example, the code 935 may include instructions executable by the at least one processor 940 to cause the device 905 to perform various aspects of multi-port reference signal resource configuration for high rank MIMO systems as described herein, or the at least one processor 940 and the at least one memory 930 may be otherwise configured to, individually or collectively, perform or support such operations.

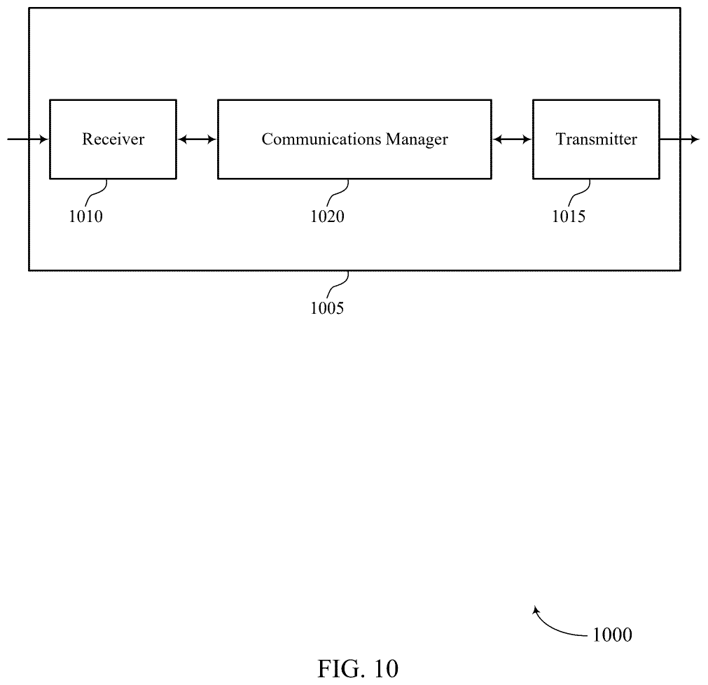

FIG. 10 shows a block diagram 1000 of a device 1005 that supports multi-port reference signal resource configuration for high rank MIMO systems in accordance with one or more aspects of the present disclosure. The device 1005 may be an example of aspects of a network entity 105 as described herein. The device 1005 may include a receiver 1010, a transmitter 1015, and a communication manager 1020. The device 1005, or one or more components of the device 1005 (e.g., the receiver 1010, the transmitter 1015, the communication manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communication manager 1020, the receiver 1010, the transmitter 1015, or various combinations or components thereof may be examples of means for performing various aspects of multi-port reference signal resource configuration for high rank MIMO systems as described herein. For example, the communication manager 1020, the receiver 1010, the transmitter 1015, or various combinations or components thereof may be capable of performing one or more of the functions described herein.

In some examples, the communication manager 1020, the receiver 1010, the transmitter 1015, or various combinations or components thereof may be implemented in hardware (e.g., in communication management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communication manager 1020, the receiver 1010, the transmitter 1015, or various combinations or components thereof may be implemented in code (e.g., as communication management software or firmware) executed by at least one processor (e.g., referred to as a processor-executable code). If implemented in code executed by at least one processor, the functions of the communication manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communication manager 1020 may be configured to perform various operations (e.g., receiving, obtaining, monitoring, outputting, transmitting) using or otherwise in cooperation with the receiver 1010, the transmitter 1015, or both. For example, the communication manager 1020 may receive information from the receiver 1010, send information to the transmitter 1015, or be integrated in combination with the receiver 1010, the transmitter 1015, or both to obtain information, output information, or perform various other operations as described herein.

The communication manager 1020 may support wireless communication in accordance with examples as disclosed herein. For example, the communication manager 1020 is capable of, configured to, or operable to support a means for outputting first information indicative of at least a first reference signal resource set, the first reference signal resource set including a set of reference signal resources. The communication manager 1020 is capable of, configured to, or operable to support a means for outputting second information indicative of a report quantity associated with at least the first reference signal resource set, where the report quantity is associated with a single reference signal resource indicator and a set of multiple measurement metrics. The communication manager 1020 is capable of, configured to, or operable to support a means for obtaining, in accordance with the report quantity, a report including an indication of a first reference signal resource indicator associated with a reference signal resource of the set of reference signal resources and a first set of multiple measurement metrics associated with the reference signal resource of the set of reference signal resources.

By including or configuring the communication manager 1020 in accordance with examples as described herein, the device 1005 (e.g., at least one processor controlling or otherwise coupled with the receiver 1010, the transmitter 1015, the communication manager 1020, or a combination thereof) may support techniques for reduced processing, reduced power consumption, and more efficient utilization of communication resources.

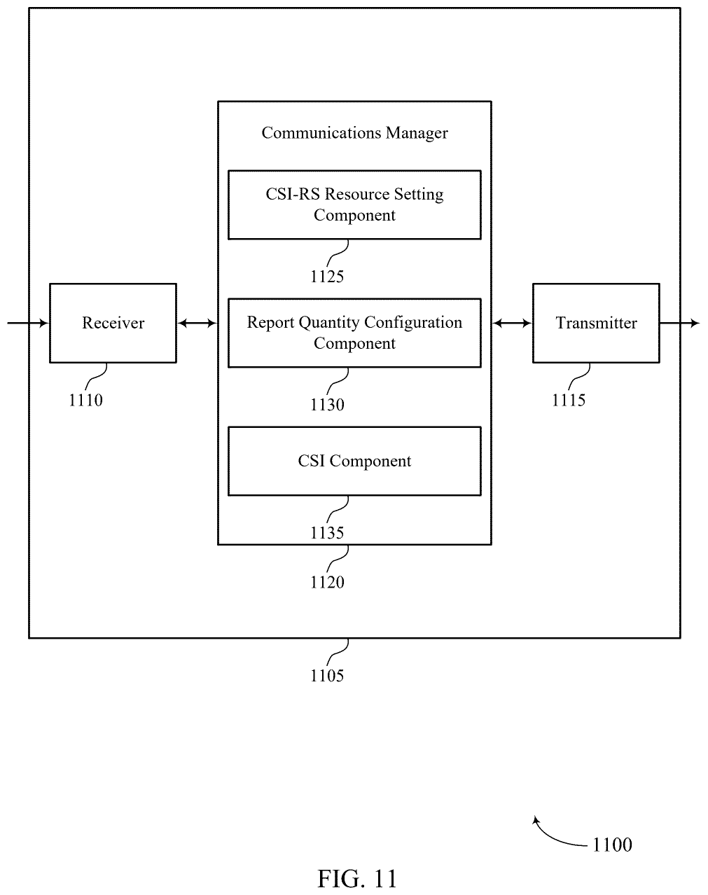

FIG. 11 shows a block diagram 1100 of a device 1105 that supports multi-port reference signal resource configuration for high rank MIMO systems in accordance with one or more aspects of the present disclosure. The device 1105 may be an example of aspects of a device 1005 or a network entity 105 as described herein. The device 1105 may include a receiver 1110, a transmitter 1115, and a communication manager 1120. The device 1105, or one or more components of the device 1105 (e.g., the receiver 1110, the transmitter 1115, the communication manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of multi-port reference signal resource configuration for high rank MIMO systems as described herein. For example, the communication manager 1120 may include a CSI-RS resource setting component 1125, a report quantity configuration component 1130, a CSI component 1135, or any combination thereof. The communication manager 1120 may be an example of aspects of a communication manager 1020 as described herein. In some examples, the communication manager 1120, or various components thereof, may be configured to perform various operations (e.g., receiving, obtaining, monitoring, outputting, transmitting) using or otherwise in cooperation with the receiver 1110, the transmitter 1115, or both. For example, the communication manager 1120 may receive information from the receiver 1110, send information to the transmitter 1115, or be integrated in combination with the receiver 1110, the transmitter 1115, or both to obtain information, output information, or perform various other operations as described herein.

The communication manager 1120 may support wireless communication in accordance with examples as disclosed herein. The CSI-RS resource setting component 1125 is capable of, configured to, or operable to support a means for outputting first information indicative of at least a first reference signal resource set, the first reference signal resource set including a set of reference signal resources. The report quantity configuration component 1130 is capable of, configured to, or operable to support a means for outputting second information indicative of a report quantity associated with at least the first reference signal resource set, where the report quantity is associated with a single reference signal resource indicator and a set of multiple measurement metrics. The CSI component 1135 is capable of, configured to, or operable to support a means for obtaining, in accordance with the report quantity, a report including an indication of a first reference signal resource indicator associated with a reference signal resource of the set of reference signal resources and a first set of multiple measurement metrics associated with the reference signal resource of the set of reference signal resources.

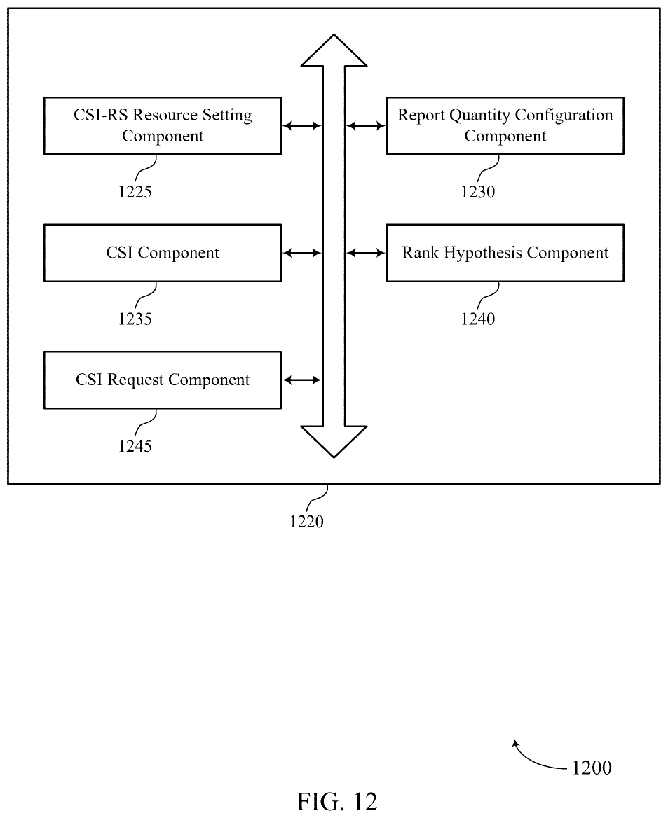

FIG. 12 shows a block diagram 1200 of a communication manager 1220 that supports multi-port reference signal resource configuration for high rank MIMO systems in accordance with one or more aspects of the present disclosure. The communication manager 1220 may be an example of aspects of a communication manager 1020, a communication manager 1120, or both, as described herein. The communication manager 1220, or various components thereof, may be an example of means for performing various aspects of multi-port reference signal resource configuration for high rank MIMO systems as described herein. For example, the communication manager 1220 may include a CSI-RS resource setting component 1225, a report quantity configuration component 1230, a CSI component 1235, a rank hypothesis component 1240, a CSI request component 1245, or any combination thereof. Each of these components, or components or subcomponents thereof (e.g., one or more processors, one or more memories), may communicate, directly or indirectly, with one another (e.g., via one or more buses). The communication may include communication within a protocol layer of a protocol stack, communication associated with a logical channel of a protocol stack (e.g., between protocol layers of a protocol stack, within a device, component, or virtualized component associated with a network entity 105, between devices, components, or virtualized components associated with a network entity 105), or any combination thereof.

The communication manager 1220 may support wireless communication in accordance with examples as disclosed herein. The CSI-RS resource setting component 1225 is capable of, configured to, or operable to support a means for outputting first information indicative of at least a first reference signal resource set, the first reference signal resource set including a set of reference signal resources. The report quantity configuration component 1230 is capable of, configured to, or operable to support a means for outputting second information indicative of a report quantity associated with at least the first reference signal resource set, where the report quantity is associated with a single reference signal resource indicator and a set of multiple measurement metrics. The CSI component 1235 is capable of, configured to, or operable to support a means for obtaining, in accordance with the report quantity, a report including an indication of a first reference signal resource indicator associated with a reference signal resource of the set of reference signal resources and a first set of multiple measurement metrics associated with the reference signal resource of the set of reference signal resources.

In some examples, the CSI-RS resource setting component 1225 is capable of, configured to, or operable to support a means for outputting, via the first information, an indication that a repetition associated with the set of reference signal resources is enabled, where obtaining the report is in association with the repetition being enabled.

In some examples, the rank hypothesis component 1240 is capable of, configured to, or operable to support a means for outputting, via the first information or the second information, an indication of a rank hypothesis associated with the set of reference signal resources, where a first quantity of the first set of multiple measurement metrics is equal to a value of the rank hypothesis.

In some examples, the first quantity of the first set of multiple measurement metrics is less than or equal to a second quantity of ports associated with the reference signal resource.

In some examples, the indication of the rank hypothesis indicates a mode of operation for communication between the network entity and a UE. In some examples, the mode of operation includes SU-MIMO operation with a rank greater than two. In some examples, obtaining the report is in accordance with the mode of operation.

In some examples, the CSI-RS resource setting component 1225 is capable of, configured to, or operable to support a means for outputting, via the first information, an indication of a mode of operation for communication between the network entity and a UE, where the mode of operation includes SU-MIMO operation with a rank greater than two, and where obtaining the report is in accordance with the mode of operation.

In some examples, a first quantity of the first set of multiple measurement metrics is based on a second quantity of ports associated with the reference signal resource.

In some examples, the CSI component 1235 is capable of, configured to, or operable to support a means for inputting, into a function, the second quantity of ports associated with the reference signal resource. In some examples, the CSI component 1235 is capable of, configured to, or operable to support a means for obtaining, as an output of the function, the first quantity.

In some examples, the CSI-RS resource setting component 1225 is capable of, configured to, or operable to support a means for outputting, via the first information, an indication of a respective set of QCL reference signals associated with each reference signal resource of the set of reference signal resources.

In some examples, a quantity of the respective set of QCL reference signals associated with each reference signal resource of the set of reference signal resources is less than or equal to a respective quantity of ports associated with that reference signal resource of the set of reference signal resources.

In some examples, the reference signal resource is associated with a set of multiple QCL reference signals of a second quantity. In some examples, a first quantity of the first set of multiple measurement metrics is based on the second quantity.

In some examples, the CSI-RS resource setting component 1225 is capable of, configured to, or operable to support a means for outputting, via the first information, an indication of a same quantity of ports associated with each reference signal resource of the set of reference signal resources, where the same quantity of ports is greater than two.

In some examples, the CSI-RS resource setting component 1225 is capable of, configured to, or operable to support a means for outputting, via the first information, an indication of a respective quantity of ports associated with each reference signal resource of the set of reference signal resources.

In some examples, the reference signal resource is associated with a first quantity of ports. In some examples, a second reference signal resource of the set of reference signal resources is associated with a second quantity of ports different than the first quantity of ports. In some examples, at least the first quantity of ports is greater than two.

In some examples, the CSI component 1235 is capable of, configured to, or operable to support a means for obtaining, via the report or a second report associated with the reference signal resource, an indication of a PMI and an indication of a CQI associated with the reference signal resource.

In some examples, the report quantity configuration component 1230 is capable of, configured to, or operable to support a means for outputting, via the second information, an indication that the report quantity is further associated with an RI. In some examples, the CSI component 1235 is capable of, configured to, or operable to support a means for obtaining, via the report, a first RI associated with the reference signal resource, where a first quantity of the first set of multiple measurement metrics is equal to a value of the first RI.

In some examples, the value of the first RI is less than or equal to a second quantity of ports associated with the reference signal resource.

In some examples, each measurement metric of the first set of multiple measurement metrics is associated with a respective MIMO layer at a UE.

In some examples, the CSI-RS resource setting component 1225 is capable of, configured to, or operable to support a means for outputting third information indicative of a CMR, where the third information includes an indication of the reference signal resource as a QCL reference signal for the CMR in accordance with the report, and where the reference signal resource is associated with a set of multiple ports in accordance with the first information.

In some examples, the CSI component 1235 is capable of, configured to, or operable to support a means for obtaining, in accordance with the third information, a second report including at least a portion of CSI associated with the CMR.

In some examples, the CSI request component 1245 is capable of, configured to, or operable to support a means for outputting a request for buffered CSI associated with the reference signal resource. In some examples, the CSI component 1235 is capable of, configured to, or operable to support a means for obtaining, in accordance with the request, a second report including the buffered CSI associated with the reference signal resource.

In some examples, the first set of multiple measurement metrics are based on an SVD of an effective channel of each MIMO layer at a UE.

In some examples, the first set of multiple measurement metrics are further based on a wideband precoder. In some examples, the wideband precoder is associated with a set of multiple precoder coefficients. In some examples, each precoder coefficient of the set of multiple precoder coefficients is applied to a respective transmit beam associated with the reference signal resource.

In some examples, the first information is associated with a beam management between the network entity and a UE. In some examples, the first set of multiple measurement metrics includes a set of multiple RSRP metrics, a set of multiple SINR metrics, or a set of multiple CQI metrics.

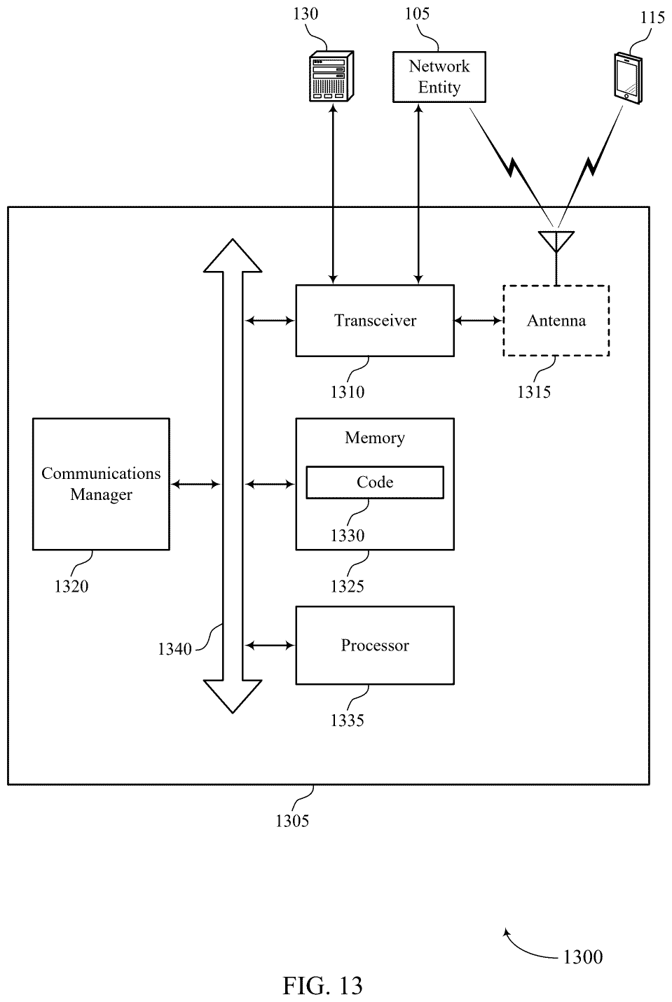

FIG. 13 shows a diagram of a system 1300 including a device 1305 that supports multi-port reference signal resource configuration for high rank MIMO systems in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communication may include communication over one or more wired interfaces, over one or more wireless interfaces, or any combination thereof. The device 1305 may include components that support outputting and obtaining communication, such as a communication manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communication via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communication via one or more communication links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting multi-port reference signal resource configuration for high rank MIMO systems). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communication of (e.g., within) a protocol layer of a protocol stack. In some examples, a bus 1340 may support communication associated with a logical channel of a protocol stack (e.g., between protocol layers of a protocol stack), which may include communication performed within a component of the device 1305, or between different components of the device 1305 that may be co-located or located in different locations (e.g., where the device 1305 may refer to a system in which one or more of the communication manager 1320, the transceiver 1310, the at least one memory 1325, the code 1330, and the at least one processor 1335 may be located in one of the different components or divided between different components).

In some examples, the communication manager 1320 may manage aspects of communication with a core network 130 (e.g., via one or more wired or wireless backhaul links). For example, the communication manager 1320 may manage the transfer of data communication for client devices, such as one or more UEs 115. In some examples, the communication manager 1320 may manage communication with one or more other network entities 105, and may include a controller or scheduler for controlling communication with UEs 115 (e.g., in cooperation with the one or more other network devices). In some examples, the communication manager 1320 may support an X2 interface within an LTE/LTE-A wireless communication network technology to provide communication between network entities 105.

The communication manager 1320 may support wireless communication in accordance with examples as disclosed herein. For example, the communication manager 1320 is capable of, configured to, or operable to support a means for outputting first information indicative of at least a first reference signal resource set, the first reference signal resource set including a set of reference signal resources. The communication manager 1320 is capable of, configured to, or operable to support a means for outputting second information indicative of a report quantity associated with at least the first reference signal resource set, where the report quantity is associated with a single reference signal resource indicator and a set of multiple measurement metrics. The communication manager 1320 is capable of, configured to, or operable to support a means for obtaining, in accordance with the report quantity, a report including an indication of a first reference signal resource indicator associated with a reference signal resource of the set of reference signal resources and a first set of multiple measurement metrics associated with the reference signal resource of the set of reference signal resources.

By including or configuring the communication manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communication manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communication manager 1320 is illustrated as a separate component, in some examples, one or more functions described with reference to the communication manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of multi-port reference signal resource configuration for high rank MIMO systems as described herein, or the at least one processor 1335 and the at least one memory 1325 may be otherwise configured to, individually or collectively, perform or support such operations.

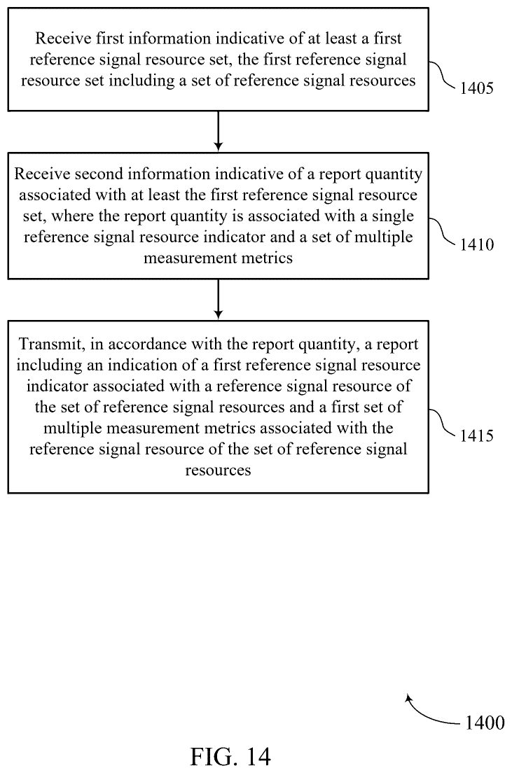

FIG. 14 shows a flowchart illustrating a method 1400 that supports multi-port reference signal resource configuration for high rank MIMO systems in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving first information indicative of at least a first reference signal resource set, the first reference signal resource set including a set of reference signal resources. The operations of 1405 may be performed in accordance with examples as disclosed herein. In some examples, aspects of the operations of 1405 may be performed by a CSI-RS resource setting component 825 as described with reference to FIG. 8.

At 1410, the method may include receiving second information indicative of a report quantity associated with at least the first reference signal resource set, where the report quantity is associated with a single reference signal resource indicator and a set of multiple measurement metrics. The operations of 1410 may be performed in accordance with examples as disclosed herein. In some examples, aspects of the operations of 1410 may be performed by a report quantity configuration component 830 as described with reference to FIG. 8.

At 1415, the method may include transmitting, in accordance with the report quantity, a report including an indication of a first reference signal resource indicator associated with a reference signal resource of the set of reference signal resources and a first set of multiple measurement metrics associated with the reference signal resource of the set of reference signal resources. The operations of 1415 may be performed in accordance with examples as disclosed herein. In some examples, aspects of the operations of 1415 may be performed by a CSI reporting component 835 as described with reference to FIG. 8.

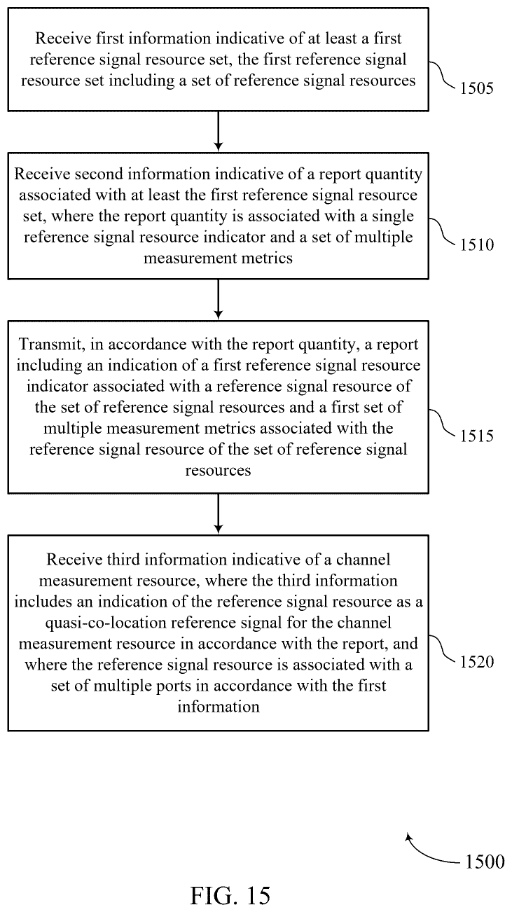

FIG. 15 shows a flowchart illustrating a method 1500 that supports multi-port reference signal resource configuration for high rank MIMO systems in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving first information indicative of at least a first reference signal resource set, the first reference signal resource set including a set of reference signal resources. The operations of 1505 may be performed in accordance with examples as disclosed herein. In some examples, aspects of the operations of 1505 may be performed by a CSI-RS resource setting component 825 as described with reference to FIG. 8.

At 1510, the method may include receiving second information indicative of a report quantity associated with at least the first reference signal resource set, where the report quantity is associated with a single reference signal resource indicator and a set of multiple measurement metrics. The operations of 1510 may be performed in accordance with examples as disclosed herein. In some examples, aspects of the operations of 1510 may be performed by a report quantity configuration component 830 as described with reference to FIG. 8.

At 1515, the method may include transmitting, in accordance with the report quantity, a report including an indication of a first reference signal resource indicator associated with a reference signal resource of the set of reference signal resources and a first set of multiple measurement metrics associated with the reference signal resource of the set of reference signal resources. The operations of 1515 may be performed in accordance with examples as disclosed herein. In some examples, aspects of the operations of 1515 may be performed by a CSI reporting component 835 as described with reference to FIG. 8.

At 1520, the method may include receiving third information indicative of a CMR, where the third information includes an indication of the reference signal resource as a QCL reference signal for the CMR in accordance with the report, and where the reference signal resource is associated with a set of multiple ports in accordance with the first information. The operations of 1520 may be performed in accordance with examples as disclosed herein. In some examples, aspects of the operations of 1520 may be performed by a CSI-RS resource setting component 825 as described with reference to FIG. 8.

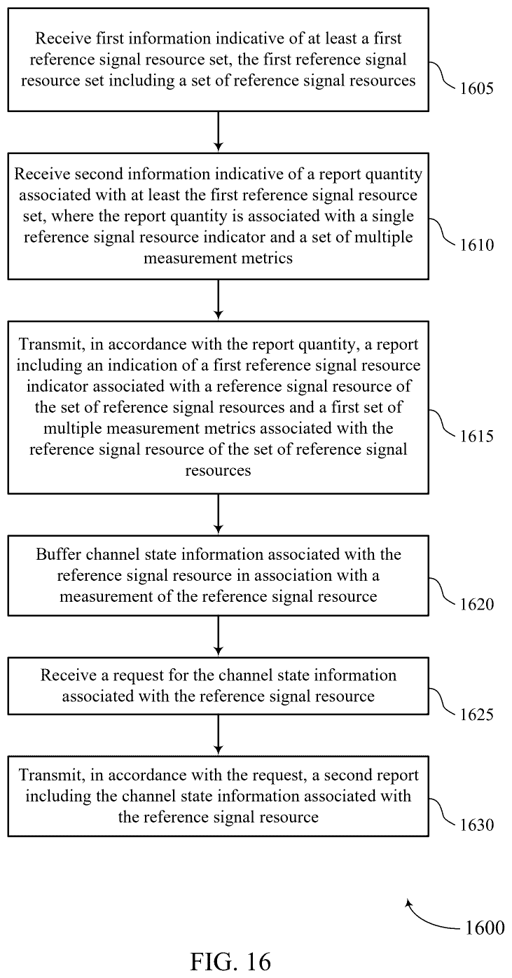

FIG. 16 shows a flowchart illustrating a method 1600 that supports multi-port reference signal resource configuration for high rank MIMO systems in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving first information indicative of at least a first reference signal resource set, the first reference signal resource set including a set of reference signal resources. The operations of 1605 may be performed in accordance with examples as disclosed herein. In some examples, aspects of the operations of 1605 may be performed by a CSI-RS resource setting component 825 as described with reference to FIG. 8.

At 1610, the method may include receiving second information indicative of a report quantity associated with at least the first reference signal resource set, where the report quantity is associated with a single reference signal resource indicator and a set of multiple measurement metrics. The operations of 1610 may be performed in accordance with examples as disclosed herein. In some examples, aspects of the operations of 1610 may be performed by a report quantity configuration component 830 as described with reference to FIG. 8.

At 1615, the method may include transmitting, in accordance with the report quantity, a report including an indication of a first reference signal resource indicator associated with a reference signal resource of the set of reference signal resources and a first set of multiple measurement metrics associated with the reference signal resource of the set of reference signal resources. The operations of 1615 may be performed in accordance with examples as disclosed herein. In some examples, aspects of the operations of 1615 may be performed by a CSI reporting component 835 as described with reference to FIG. 8.

At 1620, the method may include buffering CSI associated with the reference signal resource in association with a measurement of the reference signal resource. The operations of 1620 may be performed in accordance with examples as disclosed herein. In some examples, aspects of the operations of 1620 may be performed by a CSI buffer component 850 as described with reference to FIG. 8.

At 1625, the method may include receiving a request for the CSI associated with the reference signal resource. The operations of 1625 may be performed in accordance with examples as disclosed herein. In some examples, aspects of the operations of 1625 may be performed by a CSI request component 855 as described with reference to FIG. 8.

At 1630, the method may include transmitting, in accordance with the request, a second report including the CSI associated with the reference signal resource. The operations of 1630 may be performed in accordance with examples as disclosed herein. In some examples, aspects of the operations of 1630 may be performed by a CSI reporting component 835 as described with reference to FIG. 8.

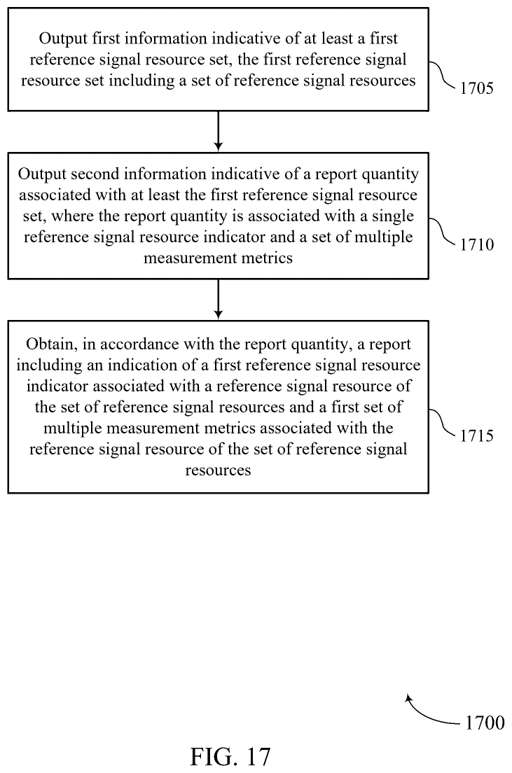

FIG. 17 shows a flowchart illustrating a method 1700 that supports multi-port reference signal resource configuration for high rank MIMO systems in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting first information indicative of at least a first reference signal resource set, the first reference signal resource set including a set of reference signal resources. The operations of 1705 may be performed in accordance with examples as disclosed herein. In some examples, aspects of the operations of 1705 may be performed by a CSI-RS resource setting component 1225 as described with reference to FIG. 12.

At 1710, the method may include outputting second information indicative of a report quantity associated with at least the first reference signal resource set, where the report quantity is associated with a single reference signal resource indicator and a set of multiple measurement metrics. The operations of 1710 may be performed in accordance with examples as disclosed herein. In some examples, aspects of the operations of 1710 may be performed by a report quantity configuration component 1230 as described with reference to FIG. 12.

At 1715, the method may include obtaining, in accordance with the report quantity, a report including an indication of a first reference signal resource indicator associated with a reference signal resource of the set of reference signal resources and a first set of multiple measurement metrics associated with the reference signal resource of the set of reference signal resources. The operations of 1715 may be performed in accordance with examples as disclosed herein. In some examples, aspects of the operations of 1715 may be performed by a CSI component 1235 as described with reference to FIG. 12.

The following provides an overview of aspects of the present disclosure:

Aspect 1: A method for wireless communication at a UE, comprising: receiving first information indicative of at least a first reference signal resource set, the first reference signal resource set comprising a set of reference signal resources; receiving second information indicative of a report quantity associated with at least the first reference signal resource set, wherein the report quantity is associated with a single reference signal resource indicator and a plurality of measurement metrics; and transmitting, in accordance with the report quantity, a report comprising an indication of a first reference signal resource indicator associated with a reference signal resource of the set of reference signal resources and a first plurality of measurement metrics associated with the reference signal resource of the set of reference signal resources.

Aspect 2: The method of aspect 1, further comprising: receiving, via the first information, an indication that a repetition associated with the set of reference signal resources is enabled, wherein transmitting the report is in association with the repetition being enabled.

Aspect 3: The method of any of aspects 1-2, further comprising: receiving, via the first information or the second information, an indication of a rank hypothesis associated with the set of reference signal resources, wherein a first quantity of the first plurality of measurement metrics is equal to a value of the rank hypothesis.

Aspect 4: The method of aspect 3, wherein the first quantity of the first plurality of measurement metrics is less than or equal to a second quantity of ports associated with the reference signal resource.

Aspect 5: The method of any of aspects 3-4, wherein the indication of the rank hypothesis indicates a mode of operation for communication between the UE and a network entity, the mode of operation comprises SU-MIMO operation with a rank greater than two, and transmitting the report is in accordance with the mode of operation.

Aspect 6: The method of any of aspects 1-5, further comprising: receiving, via the first information, an indication of a mode of operation for communication between the UE and a network entity, wherein the mode of operation comprises SU-MIMO operation with a rank greater than two, and wherein transmitting the report is in accordance with the mode of operation.

Aspect 7: The method of any of aspects 1-6, wherein a first quantity of the first plurality of measurement metrics is based at least in part on a second quantity of ports associated with the reference signal resource.

Aspect 8: The method of aspect 7, further comprising: inputting, into a function, the second quantity of ports associated with the reference signal resource; and obtaining, as an output of the function, the first quantity.

Aspect 9: The method of any of aspects 1-8, further comprising: receiving, via the first information, an indication of a respective set of QCL reference signals associated with each reference signal resource of the set of reference signal resources.

Aspect 10: The method of aspect 9, wherein a quantity of the respective set of QCL reference signals associated with each reference signal resource of the set of reference signal resources is less than or equal to a respective quantity of ports associated with that reference signal resource of the set of reference signal resources.

Aspect 11: The method of any of aspects 9-10, wherein the reference signal resource is associated with a plurality of QCL reference signals of a first quantity, and a second quantity of the first plurality of measurement metrics is based at least in part on the first quantity.

Aspect 12: The method of any of aspects 1-11, further comprising: receiving, via the first information, an indication of a same quantity of ports associated with each reference signal resource of the set of reference signal resources, wherein the same quantity of ports is greater than two.

Aspect 13: The method of any of aspects 1-12, further comprising: receiving, via the first information, an indication of a respective quantity of ports associated with each reference signal resource of the set of reference signal resources.

Aspect 14: The method of aspect 13, wherein the reference signal resource is associated with a first quantity of ports, a second reference signal resource of the set of reference signal resources is associated with a second quantity of ports different than the first quantity of ports, and at least the first quantity of ports is greater than two.

Aspect 15: The method of any of aspects 1-14, further comprising: transmitting, via the report or a second report associated with the reference signal resource, an indication of a PMI and an indication of a CQI associated with the reference signal resource.

Aspect 16: The method of any of aspects 1-15, further comprising: receiving, via the second information, an indication that the report quantity is further associated with an RI; and transmitting, via the report, a first RI associated with the reference signal resource, wherein a first quantity of the first plurality of measurement metrics is equal to a value of the first RI.

Aspect 17: The method of aspect 16, wherein the value of the first RI is less than or equal to a second quantity of ports associated with the reference signal resource.

Aspect 18: The method of any of aspects 1-17, wherein each measurement metric of the first plurality of measurement metrics is associated with a respective MIMO layer at the UE.

Aspect 19: The method of any of aspects 1-18, further comprising: receiving third information indicative of a channel measurement resource, wherein the third information comprises an indication of the reference signal resource as a QCL reference signal for the channel measurement resource in accordance with the report, and wherein the reference signal resource is associated with a plurality of ports in accordance with the first information.

Aspect 20: The method of aspect 19, further comprising: transmitting, in accordance with the third information, a second report comprising at least a portion of CSI associated with the channel measurement resource.

Aspect 21: The method of any of aspects 1-20, further comprising: buffering CSI associated with the reference signal resource in association with a measurement of the reference signal resource; receiving a request for the CSI associated with the reference signal resource; and transmitting, in accordance with the request, a second report comprising the CSI associated with the reference signal resource.

Aspect 22: The method of any of aspects 1-21, wherein the first plurality of measurement metrics are based at least in part on an SVD of an effective channel of each MIMO layer at the UE.

Aspect 23: The method of aspect 22, wherein the first plurality of measurement metrics are further based at least in part on a wideband precoder, the wideband precoder is associated with a plurality of precoder coefficients, and each precoder coefficient of the plurality of precoder coefficients is applied to a respective transmit beam associated with the reference signal resource.

Aspect 24: The method of any of aspects 1-23, further comprising: measuring each reference signal resource of the set of reference signal resources in accordance with the report quantity, wherein transmitting the report is in association with measuring each reference signal resource of the set of reference signal resources.

Aspect 25: The method of any of aspects 1-24, wherein the first information is associated with a beam management between the UE and a network entity, and the first plurality of measurement metrics comprises a plurality of RSRP metrics or a plurality of SINR metrics.

Aspect 26: A method for wireless communication at a network entity, comprising: outputting first information indicative of at least a first reference signal resource set, the first reference signal resource set comprising a set of reference signal resources; outputting second information indicative of a report quantity associated with at least the first reference signal resource set, wherein the report quantity is associated with a single reference signal resource indicator and a plurality of measurement metrics; and obtaining, in accordance with the report quantity, a report comprising an indication of a first reference signal resource indicator associated with a reference signal resource of the set of reference signal resources and a first plurality of measurement metrics associated with the reference signal resource of the set of reference signal resources.

Aspect 27: The method of aspect 26, further comprising: outputting, via the first information, an indication that a repetition associated with the set of reference signal resources is enabled, wherein obtaining the report is in association with the repetition being enabled.

Aspect 28: The method of any of aspects 26-27, further comprising: outputting, via the first information or the second information, an indication of a rank hypothesis associated with the set of reference signal resources, wherein a first quantity of the first plurality of measurement metrics is equal to a value of the rank hypothesis.

Aspect 29: The method of aspect 28, wherein the first quantity of the first plurality of measurement metrics is less than or equal to a second quantity of ports associated with the reference signal resource.

Aspect 30: The method of any of aspects 28-29, wherein the indication of the rank hypothesis indicates a mode of operation for communication between the network entity and a UE, the mode of operation comprises SU-MIMO operation with a rank greater than two, and obtaining the report is in accordance with the mode of operation.

Aspect 31: The method of any of aspects 26-30, further comprising: outputting, via the first information, an indication of a mode of operation for communication between the network entity and a UE, wherein the mode of operation comprises SU-MIMO operation with a rank greater than two, and wherein obtaining the report is in accordance with the mode of operation.

Aspect 32: The method of any of aspects 26-31, wherein a first quantity of the first plurality of measurement metrics is based at least in part on a second quantity of ports associated with the reference signal resource.

Aspect 33: The method of aspect 32, further comprising: inputting, into a function, the second quantity of ports associated with the reference signal resource; and obtaining, as an output of the function, the first quantity.

Aspect 34: The method of any of aspects 26-33, further comprising: outputting, via the first information, an indication of a respective set of QCL reference signals associated with each reference signal resource of the set of reference signal resources.

Aspect 35: The method of aspect 34, wherein a quantity of the respective set of QCL reference signals associated with each reference signal resource of the set of reference signal resources is less than or equal to a respective quantity of ports associated with that reference signal resource of the set of reference signal resources.

Aspect 36: The method of any of aspects 34-35, wherein the reference signal resource is associated with a plurality of QCL reference signals of a first quantity, and a second quantity of the first plurality of measurement metrics is based at least in part on the first quantity.

Aspect 37: The method of any of aspects 26-36, further comprising: outputting, via the first information, an indication of a same quantity of ports associated with each reference signal resource of the set of reference signal resources, wherein the same quantity of ports is greater than two.

Aspect 38: The method of any of aspects 26-37, further comprising: outputting, via the first information, an indication of a respective quantity of ports associated with each reference signal resource of the set of reference signal resources.

Aspect 39: The method of aspect 38, wherein the reference signal resource is associated with a first quantity of ports, a second reference signal resource of the set of reference signal resources is associated with a second quantity of ports different than the first quantity of ports, and at least the first quantity of ports is greater than two.

Aspect 40: The method of any of aspects 26-39, further comprising: obtaining, via the report or a second report associated with the reference signal resource, an indication of a PMI and an indication of a CQI associated with the reference signal resource.

Aspect 41: The method of any of aspects 26-40, further comprising: outputting, via the second information, an indication that the report quantity is further associated with an RI; and obtaining, via the report, a first RI associated with the reference signal resource, wherein a first quantity of the first plurality of measurement metrics is equal to a value of the first RI.

Aspect 42: The method of aspect 41, wherein the value of the first RI is less than or equal to a second quantity of ports associated with the reference signal resource.

Aspect 43: The method of any of aspects 26-42, wherein each measurement metric of the first plurality of measurement metrics is associated with a respective MIMO layer at a UE.

Aspect 44: The method of any of aspects 26-43, further comprising: outputting third information indicative of a channel measurement resource, wherein the third information comprises an indication of the reference signal resource as a QCL reference signal for the channel measurement resource in accordance with the report, and wherein the reference signal resource is associated with a plurality of ports in accordance with the first information.

Aspect 45: The method of aspect 44, further comprising: obtaining, in accordance with the third information, a second report comprising at least a portion of CSI associated with the channel measurement resource.

Aspect 46: The method of any of aspects 26-45, further comprising: outputting a request for buffered CSI associated with the reference signal resource; and obtaining, in accordance with the request, a second report comprising the buffered CSI associated with the reference signal resource.

Aspect 47: The method of any of aspects 26-46, wherein the first plurality of measurement metrics are based at least in part on an SVD of an effective channel of each MIMO layer at a UE.

Aspect 48: The method of aspect 47, wherein the first plurality of measurement metrics are further based at least in part on a wideband precoder, the wideband precoder is associated with a plurality of precoder coefficients, and each precoder coefficient of the plurality of precoder coefficients is applied to a respective transmit beam associated with the reference signal resource.

Aspect 49: The method of any of aspects 26-48, wherein the first information is associated with a beam management between the network entity and a UE, and the first plurality of measurement metrics comprises a plurality of RSRP metrics or a plurality of SINR metrics.

Aspect 50: A UE or an apparatus for wireless communication at a UE, comprising one or more memories storing processor-executable code, and one or more processors coupled with the one or more memories and individually or collectively operable to execute the code to cause the UE to perform a method of any of aspects 1-25.

Aspect 51: A UE or an apparatus for wireless communication at a UE, comprising at least one means for performing a method of any of aspects 1-25.

Aspect 52: A non-transitory computer-readable medium storing code for wireless communication, the code comprising instructions executable by one or more processors to perform a method of any of aspects 1-25.

Aspect 53: A network entity or an apparatus for wireless communication at a network entity, comprising one or more memories storing processor-executable code, and one or more processors coupled with the one or more memories and individually or collectively operable to execute the code to cause the network entity to perform a method of any of aspects 26-49.

Aspect 54: A network entity or an apparatus for wireless communication at a network entity, comprising at least one means for performing a method of any of aspects 26-49.

Aspect 55: A non-transitory computer-readable medium storing code for wireless communication, the code comprising instructions executable by one or more processors to perform a method of any of aspects 26-49.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communication systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
one or more memories; and
one or more processors coupled to the one or more memories and individually or collectively configured to cause the UE to:
receive first information indicative of at least a first reference signal resource set, the first reference signal resource set comprising a set of reference signal resources;
receive second information indicative of a report quantity associated with at least the first reference signal resource set, wherein the report quantity is associated with a single reference signal resource indicator and a plurality of measurement metrics; and
transmit, in accordance with the report quantity, a report comprising an indication of a first reference signal resource indicator associated with a reference signal resource of the set of reference signal resources and a first plurality of measurement metrics associated with the reference signal resource of the set of reference signal resources.

2. The apparatus of claim 1, wherein the one or more processors are individually or collectively further configured to cause the UE to:
receive, via the first information, an indication that a repetition associated with the set of reference signal resources is enabled, wherein transmitting the report is in association with the repetition being enabled.

3. The apparatus of claim 1, wherein the one or more processors are individually or collectively further configured to cause the UE to:
receive, via the first information or the second information, an indication of a rank hypothesis associated with the set of reference signal resources, wherein a first quantity of the first plurality of measurement metrics is equal to a value of the rank hypothesis.

4. The apparatus of claim 3, wherein the first quantity of the first plurality of measurement metrics is less than or equal to a second quantity of ports associated with the reference signal resource.

5. The apparatus of claim 3, wherein the indication of the rank hypothesis indicates a mode of operation for communication between the UE and a network entity, wherein the mode of operation comprises single user (SU) multiple-input multiple-output (MIMO) operation with a rank greater than two, and wherein transmitting the report is in accordance with the mode of operation.

6. The apparatus of claim 1, wherein the one or more processors are individually or collectively further configured to cause the UE to:
receive, via the first information, an indication of a mode of operation for communication between the UE and a network entity, wherein the mode of operation comprises single user (SU) multiple-input multiple-output (MIMO) operation with a rank greater than two, and wherein transmitting the report is in accordance with the mode of operation.

7. The apparatus of claim 1, wherein a first quantity of the first plurality of measurement metrics is based at least in part on a second quantity of ports associated with the reference signal resource, and wherein the one or more processors are individually or collectively further configured to cause the UE to:
input, into a function, the second quantity of ports associated with the reference signal resource; and
obtain, as an output of the function, the first quantity.

8. The apparatus of claim 1, wherein the one or more processors are individually or collectively further configured to cause the UE to:
receive, via the first information, an indication of a respective set of quasi-co-location reference signals associated with each reference signal resource of the set of reference signal resources.

9. The apparatus of claim 8, wherein:
a quantity of the respective set of quasi-co-location reference signals associated with each reference signal resource of the set of reference signal resources is less than or equal to a respective quantity of ports associated with that reference signal resource of the set of reference signal resources; and
the reference signal resource is associated with a plurality of quasi-co-location reference signals of a second quantity, and wherein a first quantity of the first plurality of measurement metrics is based at least in part on the second quantity.

10. The apparatus of claim 1, wherein the one or more processors are individually or collectively further configured to cause the UE to:
receive, via the first information, an indication of a same quantity of ports associated with each reference signal resource of the set of reference signal resources, wherein the same quantity of ports is greater than two.

11. The apparatus of claim 1, wherein the one or more processors are individually or collectively further configured to cause the UE to:
receive, via the first information, an indication of a respective quantity of ports associated with each reference signal resource of the set of reference signal resources, wherein:
the reference signal resource is associated with a first quantity of ports;
a second reference signal resource of the set of reference signal resources is associated with a second quantity of ports different than the first quantity of ports; and
at least the first quantity of ports is greater than two.

12. The apparatus of claim 1, wherein the one or more processors are individually or collectively further configured to cause the UE to:
transmit, via the report or a second report associated with the reference signal resource, an indication of a precoding matrix indicator and an indication of a channel quality indicator associated with the reference signal resource.

13. The apparatus of claim 1, wherein the one or more processors are individually or collectively further configured to cause the UE to:
receive, via the second information, an indication that the report quantity is further associated with a rank indication; and
transmit, via the report, a first rank indication associated with the reference signal resource, wherein a first quantity of the first plurality of measurement metrics is equal to a value of the first rank indication, and wherein the value of the first rank indication is less than or equal to a second quantity of ports associated with the reference signal resource.

14. The apparatus of claim 1, wherein each measurement metric of the first plurality of measurement metrics is associated with a respective multiple-input multiple-output (MIMO) layer at the UE.

15. The apparatus of claim 1, wherein the one or more processors are individually or collectively further configured to cause the UE to:
receive third information indicative of a channel measurement resource, wherein the third information comprises an indication of the reference signal resource as a quasi-co-location reference signal for the channel measurement resource in accordance with the report, and wherein the reference signal resource is associated with a plurality of ports in accordance with the first information; and
transmit, in accordance with the third information, a second report comprising at least a portion of channel state information associated with the channel measurement resource.

16. The apparatus of claim 1, wherein the one or more processors are individually or collectively further configured to cause the UE to:
buffer channel state information associated with the reference signal resource in association with a measurement of the reference signal resource;
receive a request for the channel state information associated with the reference signal resource; and
transmit, in accordance with the request, a second report comprising the channel state information associated with the reference signal resource.

17. The apparatus of claim 1, wherein:
the first plurality of measurement metrics are based at least in part on a singular value decomposition of an effective channel of each multiple-input multiple-output (MIMO) layer at the UE; and
the first plurality of measurement metrics are further based at least in part on a wideband precoder, wherein the wideband precoder is associated with a plurality of precoder coefficients, and wherein each precoder coefficient of the plurality of precoder coefficients is applied to a respective transmit beam associated with the reference signal resource.

18. The apparatus of claim 1, wherein:
the first information is associated with a beam management between the UE and a network entity; and
the first plurality of measurement metrics comprises a plurality of reference signal receive power (RSRP) metrics, a plurality of signal-to-interference-plus-noise ratio (SINR) metrics, or a plurality of channel quality indicator (CQI) metrics.

19. An apparatus for wireless communication at a network entity, comprising:
one or more memories; and
one or more processors coupled to the one or more memories and individually or collectively configured to cause the network entity to:
output first information indicative of at least a first reference signal resource set, the first reference signal resource set comprising a set of reference signal resources;
output second information indicative of a report quantity associated with at least the first reference signal resource set, wherein the report quantity is associated with a single reference signal resource indicator and a plurality of measurement metrics; and
obtain, in accordance with the report quantity, a report comprising an indication of a first reference signal resource indicator associated with a reference signal resource of the set of reference signal resources and a first plurality of measurement metrics associated with the reference signal resource of the set of reference signal resources.

20. A method for wireless communication at a user equipment (UE), comprising:
receiving first information indicative of at least a first reference signal resource set, the first reference signal resource set comprising a set of reference signal resources;
receiving second information indicative of a report quantity associated with at least the first reference signal resource set, wherein the report quantity is associated with a single reference signal resource indicator and a plurality of measurement metrics; and
transmitting, in accordance with the report quantity, a report comprising an indication of a first reference signal resource indicator associated with a reference signal resource of the set of reference signal resources and a first plurality of measurement metrics associated with the reference signal resource of the set of reference signal resources.
